(19) United States
(12) Patent Application Publication
(10) Pub. No.: US 2023/0318381 A1
(43) Pub. Date: Oct. 5, 2023

(54) STATOR, ELECTRIC MOTOR, COMPRESSOR, AIR CONDITIONER, AND METHOD FOR FABRICATING STATOR

(71) Applicant: Mitsubishi Electric Corporation, Tokyo (JP)

(72) Inventors: Atsushi ISHIKAWA, Tokyo (JP); Atsushi MATSUOKA, Tokyo (JP)

(21) Appl. No.: 18/004,487

(22) PCT Filed: Sep. 11, 2020
(86) PCT No.: PCT/JP2020/034397

§ 371 Date: Jan. 6, 2023

(51) Int. Cl. H02K 3/28; H02K 3/34; H02K 21/14; F25B 31/02; F24F 1/08

(52) U.S. Cl. CPC H02K 3/28; F24F 1/08; F25B 31/026; H02K 3/345; H02K 21/14

(57) ABSTRACT

A stator includes a stator core, three-phase coils attached to the stator core by distributed winding, and a first insulator insulating the three-phase coils. The three-phase coils include 2 × n U-phase coils, 2 × n V-phase coils, and 2 × n W-phase coils in a coil end. Each of the 2 × n U-phase coils, the 2 × n V-phase coils, and the 2 × n W-phase coils includes n first coils and n second coils. The n second coils are disposed outward from the n first coils in the coil end. The first insulator is disposed in the slot where the second coils are disposed.

### CROSS REFERENCE TO RELATED APPLICATION

[0001A] This application is a U.S. national stage application of International Patent Application No. PCT/JP2020/034397 filed on Sep. 11, 2020, the disclosure of which is incorporated herein by reference.

### TECHNICAL FIELD

[0001B] The present disclosure relates to a stator for an electric motor.

### BACKGROUND

A stator including three-phase coils is generally known (see, for example, Patent Reference 1). A stator core disclosed in Patent Reference 1 includes 24 slots, the three-phase coils form eight magnetic poles, and the number of slots to one magnetic pole is three. In this stator, coils of each phase are disposed for each three slots and attached to the stator core by lap winding. Two coils of the same phase are disposed in each slot. In this case, the stator has the advantage of utilizing 100% of magnetic flux from the rotor.

### PATENT REFERENCE

Patent Reference 1: Japanese Unexamined Utility Model Registration Application Publication No. S53-114012

In the case of attaching three-phase coils to a stator core by lap winding, it is difficult to attach the three-phase coils to the stator core by using an inserter (e.g., inserter 9 illustrated in FIG. 9 described later). Thus, in general, in the case of attaching three-phase coils to a stator core by lap winding, the three-phase coils are manually attached to the stator core. Accordingly, productivity of the stator decreases. In addition, in a stator with three-phase coils attached by lap winding, there are many slots in each of which two coils of different phases are disposed. An insulator needs to be disposed in the slots in each of which two coils of different phases are disposed. In this case, it takes time and effort to dispose the insulator in the slots and consequently productivity of the stator further decreases.

### SUMMARY

It is therefore an object of the present disclosure to increase productivity of a stator.

A stator according to an aspect of the present disclosure includes: a stator core including 9 × n (n is an integer equal to or larger than 1) slots; three-phase coils attached to the stator core by distributed winding and to form 4 × n magnetic poles; and a first insulator insulating the three-phase coils, wherein the three-phase coils include 2 × n U-phase coils, 2 × n V-phase coils, and 2 × n W-phase coils in a coil end of the three-phase coils, the 2 × n U-phase coils are connected in series, the 2 × n V-phase coils are connected in series, the 2 × n W-phase coils are connected in series, each of the 2 × n U-phase coils, the 2 × n V-phase coils, and the 2 × n W-phase coils includes n first coils disposed in the stator core at two-slot pitch and n second coils disposed in the stator core at three-slot pitch, the n first coils are disposed in the coil end every 360/n degrees in a circumferential direction at regular intervals, the n second coils are disposed in the coil end every 360/n degrees in the circumferential direction at regular intervals, the n second coils are disposed outward from the n first coils in a radial direction in the coil end, and the first insulator is disposed in a slot in which the second coil is disposed, of the 9 × n slots.

A stator according to another aspect of the present disclosure includes: a stator core including 9 × n (n is an integer equal to or larger than 1) slots; three-phase coils attached to the stator core by distributed winding and to form 4 × n magnetic poles; and a first insulator insulating the three-phase coils, wherein the three-phase coils include 2 × n U-phase coils, 2 × n V-phase coils, and 2 × n W-phase coils in a coil end of the three-phase coils, the 2 × n U-phase coils are connected in series, the 2 × n V-phase coils are connected in series, the 2 × n W-phase coils are connected in series, each of the 2 × n U-phase coils, the 2 × n V-phase coils, and the 2 × n W-phase coils includes n first coils disposed in the stator core at two-slot pitch and n second coils disposed in the stator core at three-slot pitch, the n first coils are disposed in the coil end every 360/n degrees in a circumferential direction at regular intervals, the n second coils are disposed in the coil end every 360/n degrees in the circumferential direction at regular intervals, the n first coils are disposed outward from the n second coils in a radial direction in the coil end, and the first insulator is disposed in a slot in which the second coil is disposed, of the 9 × n slots.

An electric motor according to another aspect of the present disclosure includes: the stator; and a rotor disposed inside the stator.

A compressor according to another aspect of the present disclosure includes: a closed container; a compression device disposed in the closed container; and the electric motor to drive the compression device.

An air conditioner according to another aspect of the present disclosure includes: the compressor; and a heat exchanger.

A method for fabricating a stator according to another aspect of the present disclosure is a method for fabricating a stator including a stator core including slots and three-phase coils including 2 × n (n is an integer equal to or larger than 1) U-phase coils, 2 × n V-phase coils, and 2 × n W-phase coils in a coil end, each of the 2 × n U-phase coils, the 2 × n V-phase coils, and the 2 × n W-phase coils includes n first coils and n second coils, the method includes: disposing the n second coils in the stator core at three-slot pitch; disposing an insulator in the slots where the second coils are disposed to insulate the n second coils; and disposing the n first coils inward from the n second coils in a radial direction at two-slot pitch.

A method for fabricating a stator according to another aspect of the present disclosure is a method for fabricating a stator including a stator core including slots and three-phase coils including 2 × n (n is an integer equal to or larger than 1) U-phase coils, 2 × n V-phase coils, and 2 × n W-phase coils in a coil end, each of the 2 × n U-phase coils, the 2 × n V-phase coils, and the 2 × n W-phase coils includes n first coils and n second coils, the method includes: disposing the n first coils in the stator core at two-slot pitch; disposing the n second coils inward from the n first coils in a radial direction at three-slot pitch; and disposing an insulator in the slots where the second coils are disposed to insulate the n second coils.

According to the present disclosure, productivity of a stator can be increased.

### BRIEF DESCRIPTION OF THE DRAWINGS

FIG. 1 is a top view schematically illustrating a structure of an electric motor according to a first embodiment.

FIG. 2 is a cross-sectional view schematically illustrating a structure of a rotor.

FIG. 3 is a top view schematically illustrating a structure of a stator.

FIG. 4 is a diagram schematically illustrating three-phase coils.

FIG. 5 is a diagram schematically illustrating arrangement of three-phase coils in slots.

FIG. 6 is a diagram illustrating an example of arrangement of insulators (also referred to as first insulators) in slots.

FIG. 7 is a diagram illustrating an example of arrangement of an insulator (also referred to as a second insulator) in coil ends.

FIG. 8 is a flowchart showing an example of a process of fabricating the stator according to the first embodiment.

FIG. 9 is a diagram illustrating an example of an inserter for inserting three-phase coils in a stator core.

FIG. 10 is a diagram illustrating an insertion step of second coils in step S11.

FIG. 11 is a diagram illustrating an insertion step of additional second coils in step S13.

FIG. 12 is a diagram illustrating an insertion step of first coils in step S14.

FIG. 13 is a top view illustrating an electric motor according to a comparative example.

FIG. 14 is a diagram illustrating arrangement of three-phase coils in slots of a stator illustrated in FIG. 13.

FIG. 15 is a top view schematically illustrating a structure of an electric motor according to a variation of the first embodiment.

FIG. 16 is a top view schematically illustrating a structure of a stator of the electric motor according to the variation of the first embodiment.

FIG. 17 is a diagram schematically illustrating three-phase coils of the electric motor according to the variation of the first embodiment.

FIG. 18 is a flowchart showing an example of a process of fabricating the stator according to the variation of the first embodiment.

FIG. 19 is a diagram illustrating an insertion step of second coils in step S11a.

FIG. 20 is a diagram illustrating an insertion step of first coils in step S13a.

FIG. 21 is a plan view schematically illustrating a structure of an electric motor according to a second embodiment.

FIG. 22 is a top view schematically illustrating a structure of a stator of the electric motor according to the second embodiment.

FIG. 23 is a diagram illustrating an example of arrangement of insulators (also referred to as first insulators) in slots.

FIG. 24 is a diagram illustrating an example of arrangement of an insulator (also referred to as a second insulator) in coil ends.

FIG. 25 is a flowchart showing an example of a process of fabricating a stator 3 according to the second embodiment.

FIG. 26 is a diagram illustrating an insertion step of first coils in step S21.

FIG. 27 is a diagram illustrating an insertion step of second coils in step S22.

FIG. 28 is a diagram illustrating an insertion step of additional second coils in step S24.

FIG. 29 is a top view schematically illustrating a structure of an electric motor according to a variation of the second embodiment.

FIG. 30 is a top view schematically illustrating a structure of a stator of the electric motor according to the variation of the second embodiment.

FIG. 31 is a flowchart showing an example of a process of fabricating the stator according to the variation of the second embodiment.

FIG. 32 is a diagram illustrating an insertion step of first coils in step S21a.

FIG. 33 is a diagram illustrating an insertion step of second coils in step S22a.

FIG. 34 is a cross-sectional view schematically illustrating a structure of a compressor according to a third embodiment.

FIG. 35 is a diagram schematically illustrating a configuration of a refrigeration air conditioning apparatus according to a fourth embodiment.

### DETAILED DESCRIPTION

### First Embodiment

In an xyz orthogonal coordinate system shown in each drawing, a z-axis direction (z axis) represents a direction parallel to an axis Ax of an electric motor 1, an x-axis direction (x axis) represents a direction orthogonal to the z-axis direction (z axis), and a y-axis direction (y axis) represents a direction orthogonal to both the z-axis direction and the x-axis direction. The axis Ax is a center of a stator 3, and is a rotation center of a rotor 2. A direction parallel to the axis Ax is also referred to as an “axial direction of the rotor 2” or simply as an “axial direction.” The radial direction refers to a radial direction of the rotor 2 or the stator 3, and is a direction orthogonal to the axis Ax. An xy plane is a plane orthogonal to the axial direction. An arrow D1 represents a circumferential direction about the axis Ax. The circumferential direction of the rotor 2 or the stator 3 will be also referred to simply as a “circumferential direction.”

### <Electric Motor 1>

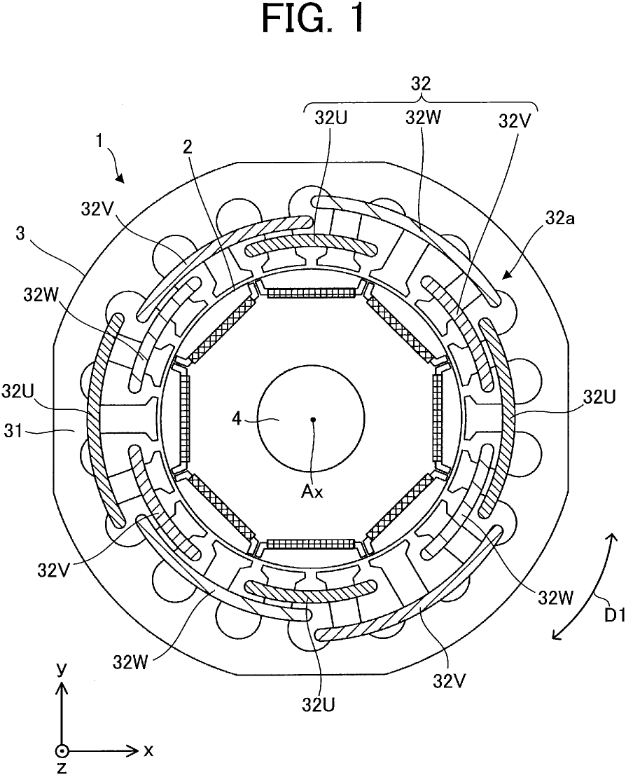

FIG. 1 is a top view schematically illustrating a structure of the electric motor 1 according to a first embodiment.

The electric motor 1 includes the rotor 2 having a plurality of magnetic poles, the stator 3, and a shaft 4 fixed to the rotor 2. The electric motor 1 is, for example, a permanent magnet synchronous motor.

The rotor 2 is rotatably disposed inside the stator 3. An air gap is present between the rotor 2 and the stator 3. The rotor 2 rotates about an axis Ax.

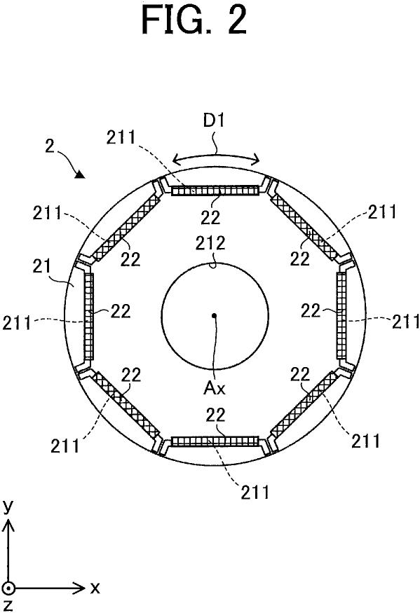

FIG. 2 is a cross-sectional view schematically illustrating a structure of the rotor 2.

The rotor 2 includes a rotor core 21 and a plurality of permanent magnets 22.

The rotor core 21 includes a plurality of magnet insertion holes 211 and a shaft hole 212 in which the shaft 4 is disposed. The rotor core 21 may further include at least one flux barrier portion that is a space communicating with each of the magnet insertion holes 211.

In this embodiment, the rotor 2 includes the plurality of permanent magnets 22. Each of the permanent magnets 22 is disposed in a corresponding one of the magnet insertion holes 211.

One permanent magnet 22 forms one magnetic pole, that is, a north pole or a south pole, of the rotor 2. It should be noted that two or more permanent magnets 22 may form one magnetic pole of the rotor 2.

In this embodiment, in the xy plane, one permanent magnet 22 forming one magnetic pole of the rotor 2 is disposed straight. Alternatively, in the xy plane, a pair of permanent magnets 22 forming one magnetic pole of the rotor 2 may be disposed in a V shape.

A center of each magnetic pole of the rotor 2 is located at a center of the north pole or the south pole of the rotor 2. Each magnetic pole (hereinafter simply referred to as “each magnetic pole” or a “magnetic pole”) of the rotor 2 refers to a region serving as a north pole or a south pole of the rotor 2.

### <Stator 3>

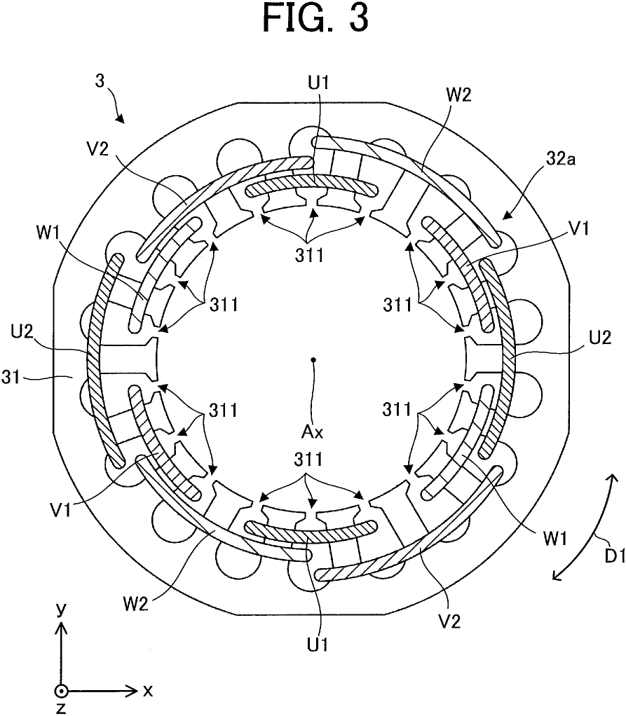

FIG. 3 is a top view schematically illustrating a structure of the stator 3.

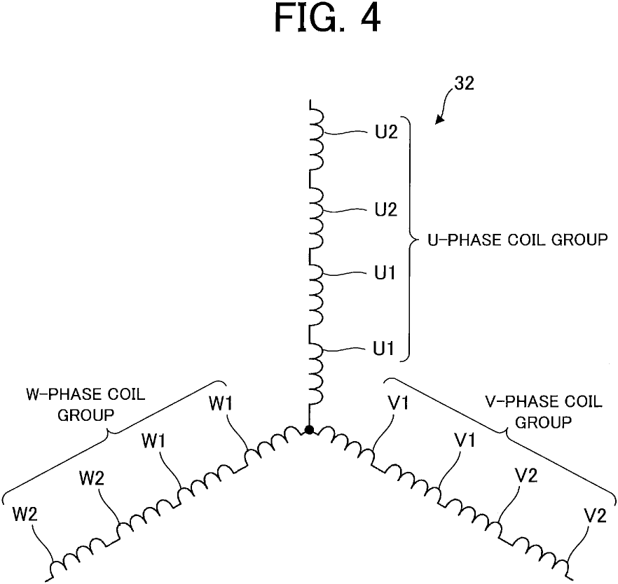

FIG. 4 is a diagram schematically illustrating three-phase coils 32.

As illustrated in FIGS. 1 and 2, the stator 3 includes a stator core 31, and three-phase coils 32 attached to the stator core 31 by distributed winding.

The stator core 31 includes 9 × n (n is an integer equal to or larger than 1) slots 311 in which the three-phase coils 32 are disposed. In this embodiment, n = 2. Thus, in the example illustrated in FIGS. 1 and 2, the stator core 31 includes 18 slots 311.

The three-phase coils 32 (i.e., coils of individual phases) include coil sides located in the slots 311 and coil ends 32a not located in the slots 311. The coil ends 32a are end portions of the three-phase coils 32 in the axial direction.

In each of the coil ends 32a, the three-phase coils 32 include 2 × n U-phase coils 32U, 2 × n V-phase coils 32V, and 2 × n W-phase coils 32W (see FIG. 1). That is, the three-phase coils 32 have three phases of a first phase, a second phase, and a third phase. For example, the first phase is a U phase, the second phase is a V phase, and the third phase is a W phase. In this embodiment, the three phases will be referred to as the U phase, the V phase, and the W phase, respectively. The 2 × n coils 32U will also be referred to as a “U-phase coil group,” the 2 × n V-phase coils 32V will also be referred to as a “V-phase coil group,” and the 2 × n W-phase coils 32W will also be referred to as a “W-phase coil group.” Each of the U-phase coil group, the V-phase coil group, and the W-phase coil group will also be referred to as a “coil group of each phase.”

The coil group of each phase includes n first coils and n second coils. The first coils are arranged in the stator core 31 at two-slot pitch. The second coils are arranged in the stator core 31 at three-slot pitch. The first coils of each phase and the second coils of each phase will also be referred to simply as “coils.”

The two-slot pitch means “each two slots.” That is, the two-slot pitch means that one coil is disposed for each two slots in the slots 311. In other words, the two-slot pitch means that one coil is disposed across one slot in the slots 311.

The three-slot pitch means “each three slots.” That is, the three-slot pitch means that one coil is disposed for each three slots in the slots 311. In other words, the three-slot pitch means that one coil is disposed across two slots in the slots 311.

In this embodiment, n = 2. Thus, in the example illustrated in FIG. 1, in the coil ends 32a, the three-phase coils 32 include four U-phase coils 32U, four V-phase coils 32V, and four W-phase coils 32W. It should be noted that the number of coils of each phase are not limited to four. In this embodiment, the stator 3 has the structure illustrated in FIG. 1 in two coil ends 32a. It should be noted that the stator 3 only needs to have the structure illustrated in FIG. 1 in one of the two coil ends 32a.

When current flows in the three-phase coils 32, the three-phase coils 32 form 4 × n magnetic poles. In this embodiment, n = 2. Thus, in this embodiment, when current flows in the three-phase coils 32, the three-phase coils 32 form eight magnetic poles.

As illustrated in FIG. 4, the 2 × n U-phase coils 32U (i.e., the first coils U1 and the second coils U2), the 2 × n V-phase coils 32V (i.e., the first coils V1 and the second coils V2), and the 2 × n W-phase coils 32W (i.e., the first coils W1 and the second coils W2) are connected by, for example, Y connection. Alternatively, the 2 × n U-phase coils 32U, the 2 × n V-phase coils 32V, and the 2 × n W-phase coils 32W may be connected by connection other than Y connection, such as delta connection.

The n first coils of each phase are disposed in the coil ends 32a every 360/n degrees in the circumferential direction at regular intervals. In this embodiment, for example, the two first coils U1 of the U phase are arranged every 180 degrees at regular intervals in the circumferential direction in the coil ends 32a. In other words, the n first coils U1 are shifted from one another by 360/n degrees and arranged at regular intervals in the coil ends 32a. In this embodiment, the two first coils U1 of the U phase are shifted from one another by 180 degrees and arranged at regular intervals in the coil ends 32a. In the case of n = 1, the first coil of each phase is disposed at an arbitrary position in the coil ends 32a.

The n second coils of each phase are disposed in the coil ends 32a every 360/n degrees in the circumferential direction at regular intervals. In this embodiment, for example, the two second coils U2 of the U phase are arranged every 180 degrees at regular intervals in the circumferential direction in the coil ends 32a. In other words, the n second coils U2 are shifted from one another by 360/n degrees and arranged at regular intervals in the coil ends 32a. In this embodiment, the two second coils U2 of the U phase are shifted from one another by 180 degrees and arranged at regular intervals in the coil ends 32a. In the case of n = 1, the second coil of each phase is disposed at an arbitrary position in the coil ends 32a.

In the coil ends 32a, two first coils adjacent to each other in the circumferential direction are shifted from each other by an electrical angle of 240 degrees (i.e., mechanical angle of 60 degrees) in the circumferential direction. In the coil ends 32a, two second coils adjacent to each other in the circumferential direction are shifted from each other by an electrical angle of 240 degrees (i.e., mechanical angle of 60 degrees) in the circumferential direction.

In the coil ends 32a of the three-phase coils 32, a region where the coils are disposed is divided into a plurality of regions, for example, an inner region and an outer region. The inner region is a region closest to the center of the stator core 31. The outer region is a region farthest from the center of the stator core 31. That is, the outer region is a region located outward from the inner region in the xy plane, and the inner region is a region located inward from the outer region in the xy plane. Each of the inner region and the outer region is a region extending in the circumferential direction.

In this embodiment, in the coil ends 32a, the first coils are disposed in the inner region, and the second coils are disposed in the outer region. That is, the first coils are disposed inward from the second coils in the radial direction in the coil ends 32a. In the coil ends 32a, the second coils are disposed outward from the first coils in the radial direction.

In this embodiment, the outer region where the second coils are disposed may be divided into a first outer region and a second outer region. The second outer region is a region located outward from the inner region in the xy plane, and the first outer region is a region located outward from the second outer region in the xy plane. That is, the second outer region is a region located between the inner region and the first outer region. Each of the first outer region and the second outer region is a region extending in the circumferential direction. In this case, as illustrated in FIGS. 1 and 3, one second coil of each phase is disposed in the first outer region, and the other second coil of each phase is disposed in the second outer region. Thus, in each phase, one second coil is disposed outward from the other second coil in the radial direction.

In the coil ends 32a, the first coils U1 of the U phase, the first coils W1 of the W phase, and the first coils V1 of the V phase are arranged in this order in the circumferential direction (counterclockwise in FIG. 3). In the coil ends 32a, the second coils U2 of the U phase, the second coils W2 of the W phase, and the second coils V2 of the V phase are arranged in this order in the circumferential direction (counterclockwise in FIG. 3). The second coils are disposed in the slots 311 together with the second coils of another phase.

When seen in the circumferential direction, the coils are wound around the stator core 31 in the same direction.

### <U-phase Coils 32U>

As illustrated in FIG. 3, the 2 × n U-phase coils 32U include n first coils U1 and n second coils U2. In this embodiment, two U-phase coils 32U are constituted by one first coil U1 and one second coil U2. The 2 × n U-phase coils 32U are connected in series. Thus, in this embodiment, two first coils U1 and two second coils U2 are connected in series. The first coils U1 are disposed in the stator core 31 at two-slot pitch. The second coils U2 are disposed in the stator core 31 at three-slot pitch.

As illustrated in FIG. 3, the first coils U1 of the U phase are disposed across one slot in two slots 311 at one side of the stator core 31. In other words, the first coils U1 of the U phase are disposed in two slots 311 with one slot 311 interposed therebetween at one side of the stator core 31.

As illustrated in FIG. 3, the second coils U2 of the U phase are disposed across two slots in two slots 311 at one side of the stator core 31. In other words, the second coils U2 of the U phase are disposed in two slots 311 with two slots 311 interposed therebetween at one side of the stator core 31.

The n first coils U1 of the U phase are disposed in the coil ends 32a every 360/n degrees in the circumferential direction at regular intervals. It should be noted that in the case of n = 1, the first coil U1 is disposed at an arbitrary position in the coil ends 32a. The n second coils U2 of the U phase are disposed in the coil ends 32a every 360/n degrees in the circumferential direction at regular intervals. It should be noted that in the case of n = 1, the second coil U2 is disposed at an arbitrary position in the coil ends 32a.

The first coils U1 are disposed inward from the second coils of another phase in the radial direction in the coil ends 32a. The second coils U2 are disposed outward from the first coils of another phase in the radial direction in the coil ends 32a.

### <V-phase Coils 32V>

As illustrated in FIG. 3, the 2 × n V-phase coils 32V include n first coils V1 and n second coils V2. In this embodiment, two V-phase coils 32V are constituted by one first coil V1 and one second coil V2. The 2 × n V-phase coils 32V are connected in series. Thus, in this embodiment, two first coils V1 and two second coils V2 are connected in series. The first coils V1 are disposed in the stator core 31 at two-slot pitch. The second coils V2 are disposed in the stator core 31 at three-slot pitch.

As illustrated in FIG. 3, the first coils V1 of the V phase are disposed across one slot in two slots 311 at one side of the stator core 31. In other words, the first coils V1 of the V phase are disposed in two slots 311 with one slot 311 interposed therebetween at one side of the stator core 31.

As illustrated in FIG. 3, the second coils V2 of the V phase are disposed across two slots in two slots 311 at one side of the stator core 31. In other words, the second coils V2 of the V phase are disposed in two slots 311 with two slots 311 interposed therebetween at one side of the stator core 31.

The n first coils V1 of the V phase are disposed in the coil ends 32a every 360/n degrees in the circumferential direction at regular intervals. It should be noted that in the case of n = 1, the first coil V1 is disposed at an arbitrary position in the coil ends 32a. The n second coils V2 of the V phase are disposed in the coil ends 32a every 360/n degrees in the circumferential direction at regular intervals. It should be noted that in the case of n = 1, the second coil V2 is disposed at an arbitrary position in the coil ends 32a.

The first coils V1 are disposed inward from the second coils of another phase in the radial direction in the coil ends 32a. The second coils V2 are disposed outward from the first coils of another phase in the radial direction in the coil ends 32a.

### <W-phase Coils 32W>

As illustrated in FIG. 3, the 2 × n W-phase coils 32W include n first coils W1 and n second coils W2. In this embodiment, two W-phase coils 32W are constituted by one first coil W1 and one second coil W2. The 2 × n W-phase coils 32W are connected in series. Thus, in this embodiment, two first coils W1 and two second coils W2 are connected in series. The first coils W1 are disposed in the stator core 31 at two-slot pitch. The second coils W2 are disposed in the stator core 31 at three-slot pitch.

As illustrated in FIG. 3, the first coils W1 of the W phase are disposed across one slot in two slots 311 at one side of the stator core 31. In other words, the first coils W1 of the W phase are disposed in two slots 311 with one slot 311 interposed therebetween at one side of the stator core 31.

As illustrated in FIG. 3, the second coils W2 of the W phase are disposed across two slots in two slots 311 at one side of the stator core 31. In other words, the second coils W2 of the W phase are disposed in two slots 311 with two slots 311 interposed therebetween at one side of the stator core 31.

The n first coils W1 of the W phase are disposed in the coil ends 32a every 360/n degrees in the circumferential direction at regular intervals. It should be noted that in the case of n = 1, the first coil W1 is disposed at an arbitrary position in the coil ends 32a. The n second coils W2 of the W phase are disposed in the coil ends 32a every 360/n degrees in the circumferential direction at regular intervals. It should be noted that in the case of n = 1, the second coil W2 is disposed at an arbitrary position in the coil ends 32a.

The first coils W1 are disposed inward from the second coils of another phase in the radial direction in the coil ends 32a. The second coils W2 are disposed outward from the first coils of another phase in the radial direction in the coil ends 32a.

### <Summary of Arrangement of Coils in Slots 311>

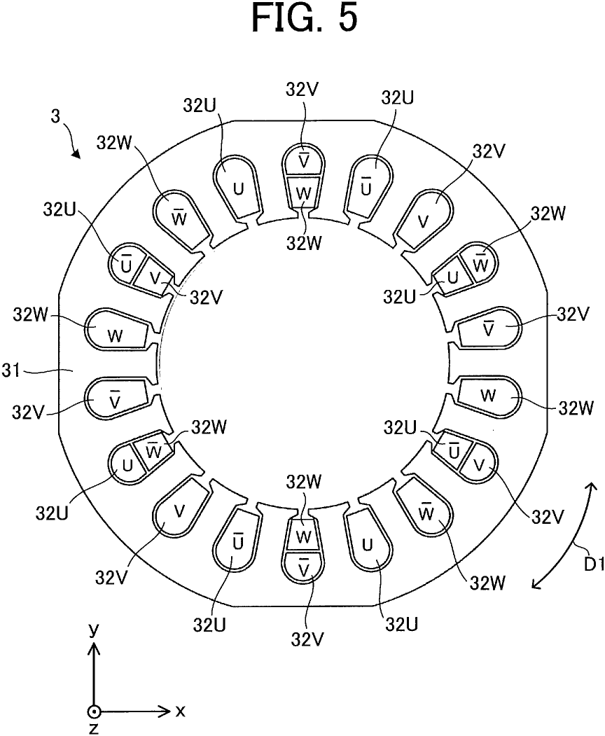

FIG. 5 is a diagram schematically illustrating arrangement of the three-phase coils 32 in the slots 311.

In a case where coils of different phases are disposed in one slot 311, the region of this slot 311 is divided into two regions. In this case, the region of the slot 311 is divided into an inner layer and an outer layer located outward from the inner layer.

### <Insulator>

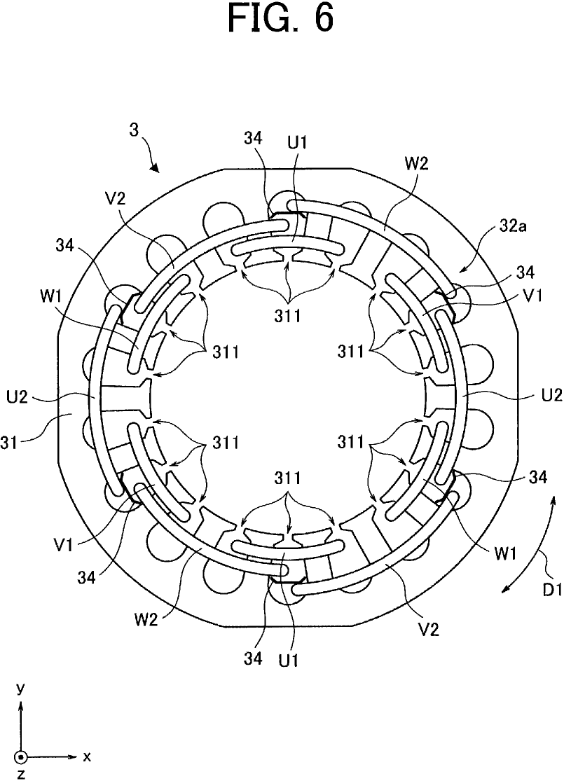

FIG. 6 is a diagram illustrating an example of arrangement of insulators 34 (also referred to as first insulators) in the slots 311.

The stator 3 may include the insulators 34 that insulate coils of each phase of the three-phase coils 32. The insulators 34 are, for example, insulating paper. In the example illustrated in FIG. 6, the insulator 34 are disposed in slots 311 where the second coils are disposed in 9 × n slots 311. Specifically, each of the insulators 34 is disposed between two second coils in the slots 311.

In a case where coils of two different phases are disposed in one slot 311, a potential difference occurs between these two coils during rotation of the rotor 2. Thus, in the case where the insulator 34 is disposed between the two coils, dielectric breakdown of coating covering the coils due to the potential difference can be prevented.

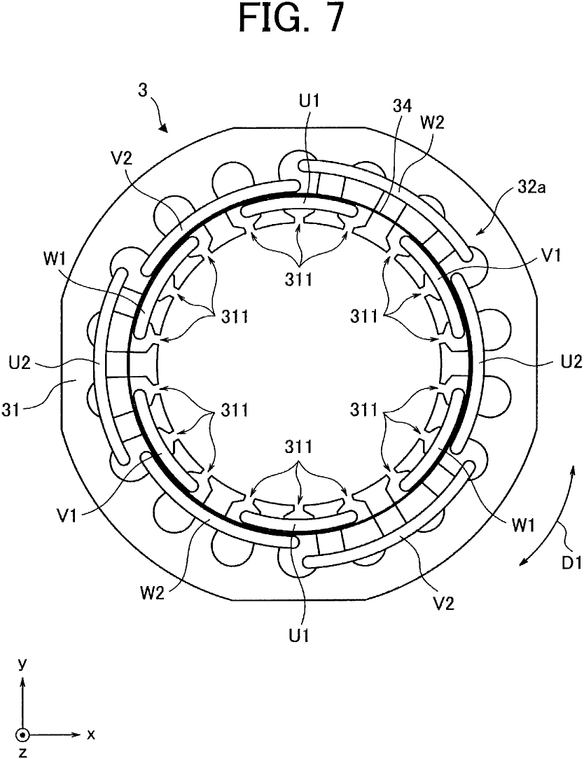

FIG. 7 is a diagram illustrating an example of arrangement of an insulator 34 (also referred to as a second insulator) in the coil ends 32a.

The stator 3 may include the insulator 34 that insulates coils of each phase of the three-phase coils 32 in the coil ends 32a. The insulator 34 is, for example, insulating paper. In the example illustrated in FIG. 7, the insulator 34 is disposed between the first coils and the second coils in the coil ends 32a.

### <Winding Factor>

In this embodiment, a winding factor kw1 of the first coils is different from a winding factor kw2 of the second coils in each phase. Thus, to calculate a winding factor kw of the stator 3 of the electric motor 1, the winding factor kw1 of the first coils of each phase and the winding factor kw2 of the second coils of each phase are calculated.

A short-pitch winding factor Kp1 of the first coils of each phase and a short-pitch winding factor Kp2 of second coils of each phase are obtained by the following equations (1), (2), (3), and (4):

$$\begin{matrix}\text{β} 1 = 2 \left[\text{slot} \text{pitch}\right] / \left(\text{18} \left[\text{slot}\right] / \text{8} \left[\text{magnetic} \text{pole}\right]\right) \\ = 8 / 9\end{matrix} \qquad \text{(1)}$$

$$\begin{matrix}\text{Kp} 1 = sin \left\{\left(\text{β} 1 \times π\right) / 2\right\} \\ = sin \left\{\left(8 / 9\right) \times \left(π / 2\right)\right\} \\ = sin 80 ° \\ = 0.985\end{matrix} \qquad \text{(2)}$$

$$\begin{matrix}\text{β} 2 = 3 \left[\text{slot} \text{pitch}\right] / \left(\text{18} \left[\text{slot}\right] / \text{8} \left[\text{magnetic} \text{pole}\right]\right) \\ = 4 / 3\end{matrix} \qquad \text{(3)}$$

$$\begin{matrix}\text{Kp2} = sin \left\{\left(\text{β2} \times π\right) / 2\right\} \\ = sin \left\{\left(4 / 3\right) \times \left(π / 2\right)\right\} \\ = sin 120 ° \\ = 0.866\end{matrix} \qquad \text{(4)}$$

A distributed winding factor kd of the stator 3 of the electric motor 1 is one. Thus, a winding factor kw of the stator 3 of the electric motor 1 is obtained by the following equation (5):

$$\begin{matrix}\text{kw} = \left\{\left(2 / 3\right) \times \text{kp} 1 + \left(1 / 3\right) \times \text{kp} 2\right\} \times \text{kd} 1 \\ = \left\{\left(2 / 3\right) \times 0.985 + \left(1 / 3\right) \times 0.866\right\} \times 1 \\ = 0.945\end{matrix} \qquad \text{(5)}$$

### <Method for Fabricating Stator 3 in First Embodiment>

An example of a method for fabricating the stator 3 will be described.

An example of a method for fabricating the stator 3 will be specifically described below.

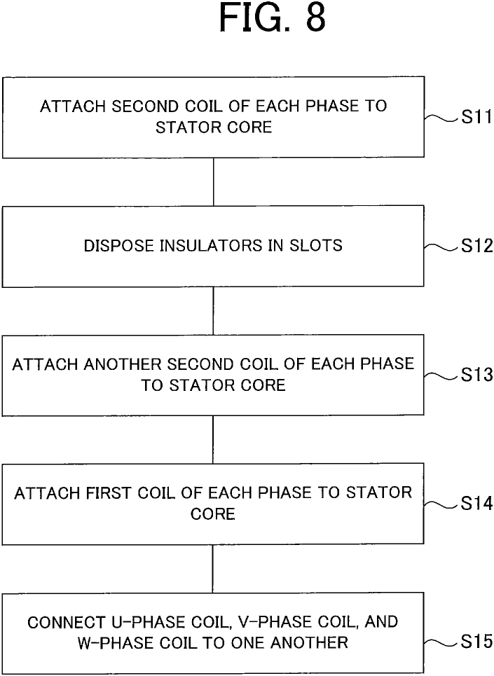

FIG. 8 is a flowchart showing an example of a process of fabricating the stator 3 according to the first embodiment.

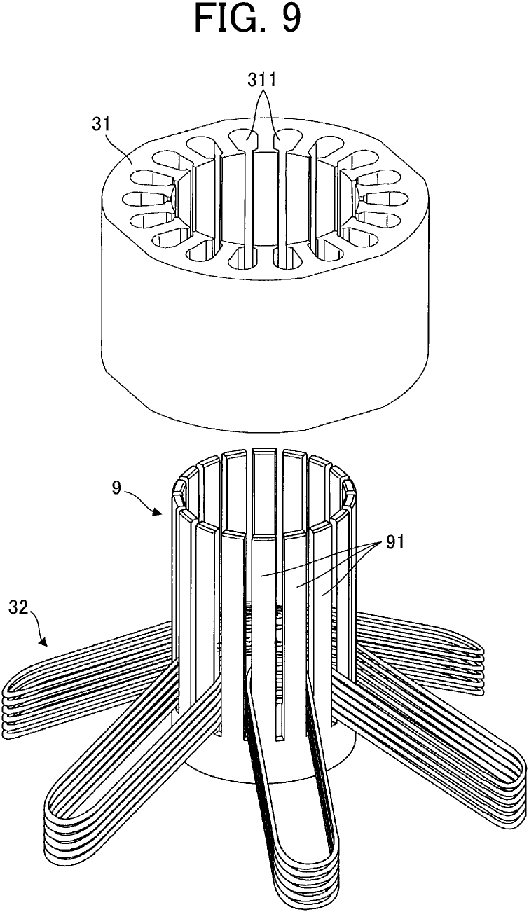

FIG. 9 is a diagram illustrating an example of an inserter 9 for inserting the three-phase coils 32 in the stator core 31.

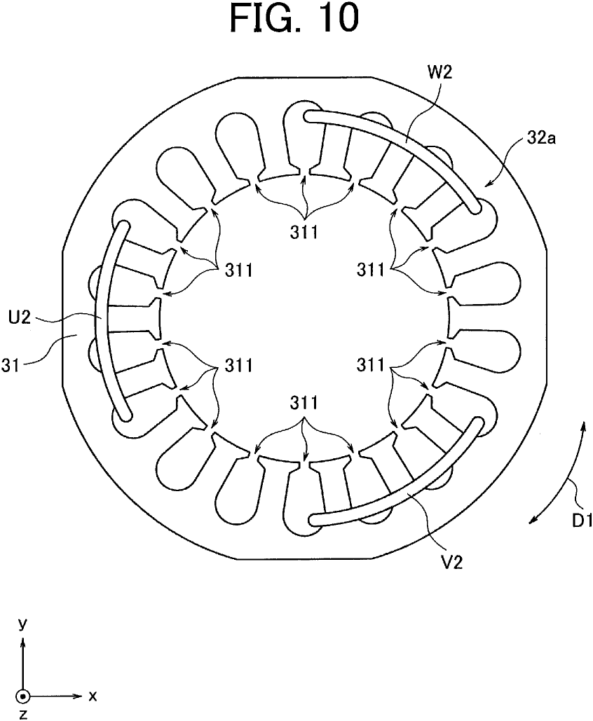

FIG. 10 is a diagram illustrating an insertion step of second coils in step S11.

In step S11, as illustrated in FIG. 10, second coils 9 of the phases are attached to a previously prepared stator core 31 by the inserter 9. Specifically, second coils each of which corresponds to one of the phases are disposed at regular intervals (specifically 120 degrees) in the circumferential direction in the coil ends 32a, and disposed in the outer layers of the slots 311 of the stator core 31 by distributed winding. That is, one second coil U2 in the U-phase coils 32U, one second coil V2 in the V-phase coils 32V, and one second coil W2 in the W-phase coils 32W are disposed in the outer layers of the slots 311 by distributed winding. As a result, one second coil of each phase is disposed in the outer region (specifically the first outer region) in the coil end 32a, and disposed in the stator core 31 at three-slot pitch.

In the case of inserting the three-phase coils 32 in the stator core 31 by the inserter 9 illustrated in FIG. 9, the coils are disposed between blades 91 of the inserter 9, and the blades 91 are inserted in the inside of the stator core 31 together with the coils. Next, the coils are slid in the axial direction to be disposed in the slots 311. In subsequent steps described later, the three-phase coils 32 are inserted in the stator core 31 in the same manner.

In step S12, the insulator 34 is disposed in the slots 311 where the second coils of each of the phases are disposed to insulate the second coils of each of the phases. Specifically, the insulator 34 is disposed in the slots 311 where the second coils of different phases are to be disposed in the next step.

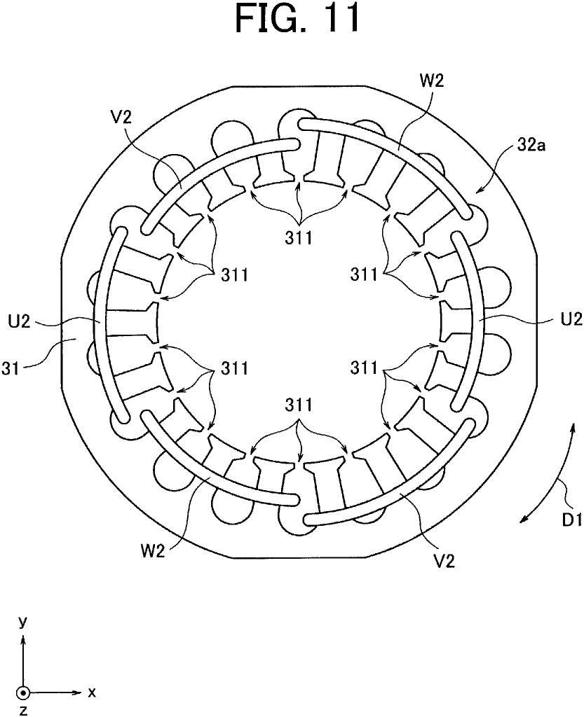

FIG. 11 is a diagram illustrating an insertion step of additional second coils in step S13.

In step S13, as illustrated in FIG. 11, another second coil of each phase is attached to the stator core 31 by the inserter 9. Specifically, other second coils each of which corresponds to one of the phases are disposed at regular intervals in the circumferential direction in the coil ends 32a, and disposed by distributed winding in the inner layers of the slots 311 where the second coils are already disposed. That is, another second coil of each phase is disposed in the outer region (specifically the second outer region) in the coil ends 32a.

As a result, the second coils of the phases are disposed in the outer region in the coil ends 32a, and are arranged in the stator core 31 at three-slot pitch. Regarding the second coils of each of the phases, in the coil ends 32a, the second coils U2 of the U phase, the second coils W2 of the W phase, and the second coils V2 of the V phase are arranged in this order in the circumferential direction (counterclockwise in FIG. 11). The second coils are disposed in the slots 311 together with second coils of other phases.

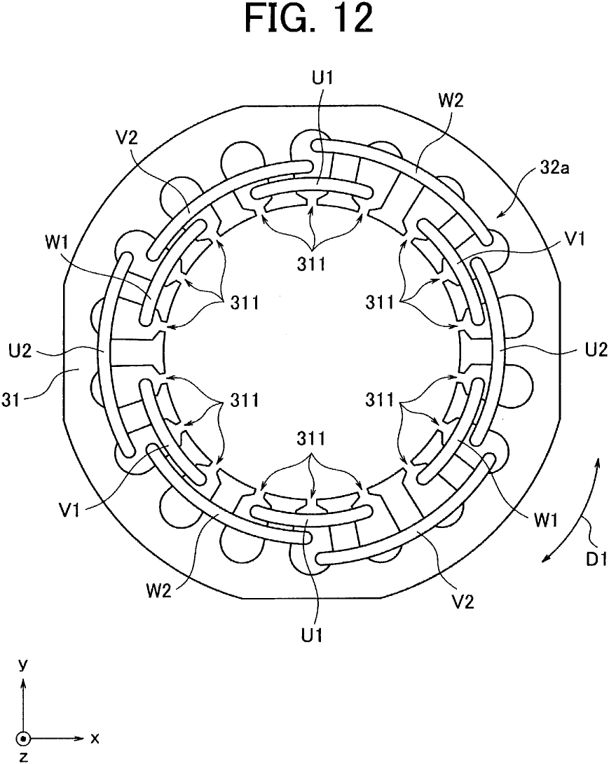

FIG. 12 is a diagram illustrating an insertion step of first coils in step S14.

In step S14, as illustrated in FIG. 11, first coils of each phase are attached to the stator core 31 by the inserter 9. Specifically, in the coil ends 32a, the first coils of each of the phases are arranged at regular intervals in the circumferential direction, and are disposed in the slots 311 by distributed winding. That is, the first coils U1 of the U-phase coils 32U, the first coils V1 of the V-phase coils 32V, and the first coils W1 of the W-phase coils 32W are disposed in the slots 311 by distributed winding. As a result, the first coils of each of the phases are disposed in the inner region in the coil ends 32a, and disposed inward from the second coils in the radial direction at two-slot pitch.

As described above, in steps S11 through S14, the first coils are disposed in the stator core 31 at two-slot pitch by distributed winding, and the second coils are disposed in the stator core 31 at three-slot pitch by distributed winding. As a result, the three-phase coils 32 are attached to the stator core 31 by distributed winding such that the three-phase coils 32 have the arrangement described in this embodiment in the coil ends 32a of the three-phase coils 32 and the slots 311.

In step S15, the U-phase coils 32U, the V-phase coils 32V, and the W-phase coils 32W are connected to one another. The coils of each phase are connected in series. Specifically, the 2 × n U-phase coils 32U are connected in series, the 2 × n V-phase coils 32V are connected in series, and the 2 × n W-phase coils 32W are connected in series. The U-phase coils 32U, the V-phase coils 32V, and the W-phase coils 32W are connected by Y connection, for example. Thereafter, the shape of the connected three-phase coils 32 are appropriately adjusted. Consequently, the stator 3 illustrated in FIG. 3 is obtained.

### <Comparative Examples>

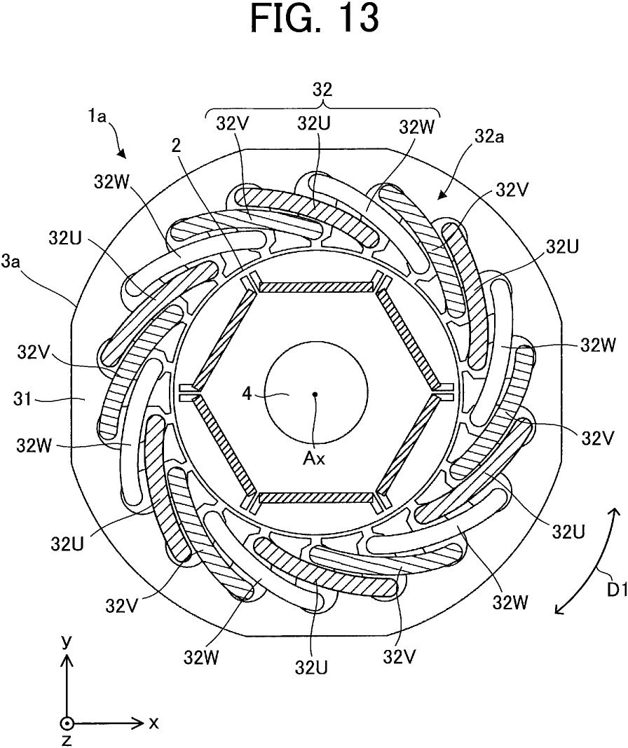

FIG. 13 is a top view illustrating an electric motor 1a according to a comparative example.

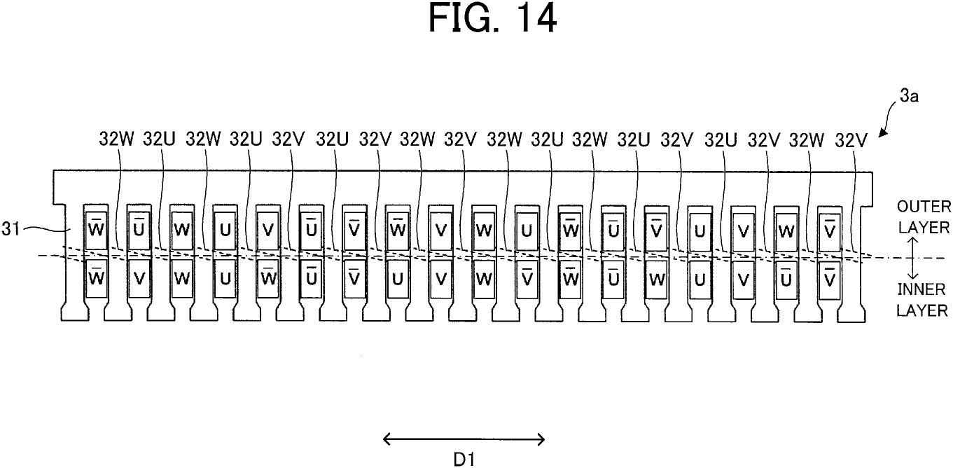

FIG. 14 is a diagram illustrating arrangement of three-phase coils 32 in slots of a stator 3a illustrated in FIG. 13. FIG. 14 is a development view of the stator 3a illustrated in FIG. 13.

In the comparative example, the three-phase coils 32 are attached to a stator core 31 by lap winding. In this case, in each coil end 32a, one end of each coil is disposed in an outer layer of a slot 311, and the other end of the coil is disposed in an inner layer of another slot 311.

Thus, in the case of attaching the three-phase coils 32 to the stator core 31 by lap winding, it is difficult to attach the three-phase coils 32 to the stator core 31 by using an inserter (e.g., the inserter 9 illustrated in FIG. 9). Thus, in general, in the case of attaching the three-phase coils 32 to the stator core 31 by lap winding as described in the comparative example, the three-phase coils 32 are manually attached to the stator core. In this case, productivity of the stator 3 decreases.

In this embodiment, since the stator 3 has the arrangement described above, the three-phase coils 32 can be easily attached to the stator core 31 by using an inserter (e.g., inserter 9 illustrated in FIG. 9). Thus, productivity of the stator 3 can be increased. In addition, in this embodiment, since the stator 3 has the arrangement described above, an insulator 34 can be easily disposed in slots 311, and productivity of the stator 3 can be further increased.

With the method for fabricating the stator 3 according to the first embodiment, the stator 3 having the advantages described in this embodiment can be fabricated. In addition, with the method for fabricating the stator 3, the three-phase coils 32 can be attached to the stator core 31 by using the inserter 9. Furthermore, since the second coils are first disposed in the outer region, the first coils can be easily disposed in the stator core 31, and a height of the coil ends 32a in the axial direction can be reduced.

### Variation of First Embodiment

### <Electric Motor 1>

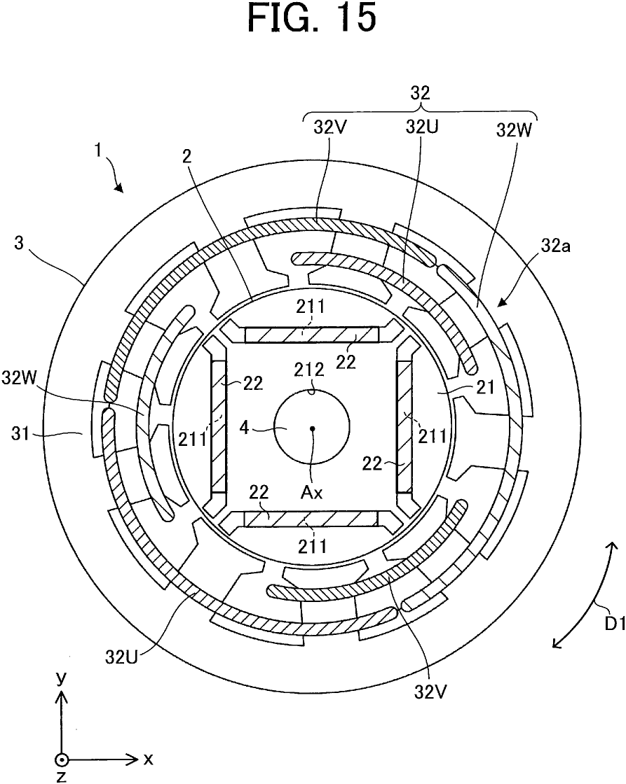

FIG. 15 is a top view schematically illustrating a structure of an electric motor 1 according to a variation of the first embodiment.

In this variation, the value of “n” is different from the value of “n” described in the first embodiment. In the variation, n = 1. In the variation, a part of the configuration different from that of the first embodiment will be described. Details not described in the variation are the same as those in the first embodiment.

The rotor 2 includes a rotor core 21 and at least one permanent magnet 22. The rotor 2 has 4 × n (n is an integer equal to or larger than 1) magnetic poles. In the variation, the rotor 2 has four magnetic poles.

### <Stator 3>

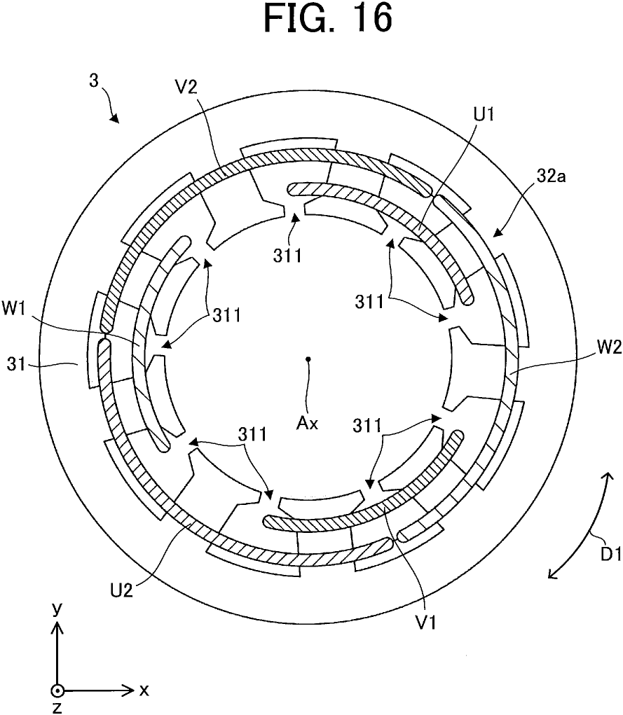

FIG. 16 is a top view schematically illustrating a structure of a stator 3 of the electric motor 1 according to the variation of the first embodiment.

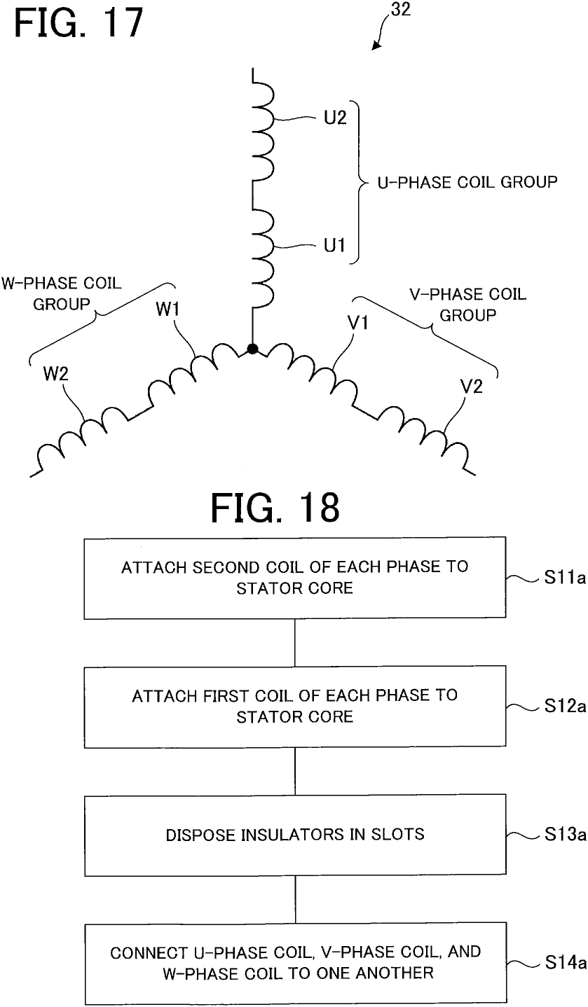

FIG. 17 is a diagram schematically illustrating three-phase coils 32 of the electric motor 1 according to the variation of the first embodiment.

A stator core 31 has 9 × n slots 311 in which the three-phase coils 32 are disposed. In the variation, n = 1. Thus, in the variation, the stator core 31 has nine slots 311.

In the example illustrated in FIG. 16, in each coil end 32a, the three-phase coils 32 include two U-phase coils 32U, two V-phase coils 32V, and two W-phase coils 32W.

When current flows in the three-phase coils 32, the three-phase coils 32 form 4 × n magnetic poles. In the variation, n = 1. Thus, in the variation, when current flows through the three-phase coils 32, the three-phase coils 32 form four magnetic poles.

In the variation of the first embodiment, the coil group of each phase includes one first coil and one second coil. The first coils are arranged in the stator core 31 at two-slot pitch. The second coils are arranged in the stator core 31 at three-slot pitch.

As illustrated in FIGS. 17, 2 × n U-phase coils 32U (i.e., one first coil U1 and one second coil U2), 2 × n V-phase coils 32V (i.e., one first coil V1 and one second coil V2), and 2 × n W-phase coils 32W (i.e., one first coil W1 and one second coil W2) are connected by, for example, Y connection. Alternatively, the 2 × n U-phase coils 32U, the 2 × n V-phase coils 32V, and the 2 × n W-phase coils 32W may be connected by connection other than Y connection, such as delta connection.

### <U-phase Coils 32U>

The 2 × n U-phase coils 32U include n first coils U1 and n second coils U2. In the variation, the four U-phase coils 32U are constituted by two first coils U1 and two second coils U2. The 2 × n U-phase coils 32U are connected in series. Thus, in the variation, one first coil U1 and one second coil U2 are connected in series. The first coil U1 is disposed in the stator core 31 at two-slot pitch. The second coil U2 is disposed in the stator core 31 at three-slot pitch.

### <V-phase Coils 32V>

The 2 × n V-phase coils 32V include n first coils V1 and n second coils V2. In the variation, the four V-phase coils 32V are constituted by two first coils V1 and two second coils V2. The 2 × n V-phase coils 32V are connected in series. Thus, in the variation, one first coil V1 and one second coil V2 are connected in series. The first coil V1 is disposed in the stator core 31 at two-slot pitch. The second coil V2 is disposed in the stator core 31 at three-slot pitch.

### <W-phase Coils 32W>

The 2 × n W-phase coils 32W include n first coils W1 and n second coils W2. In the variation, four W-phase coils 32W are constituted by two first coils W1 and two second coils W2. The 2 × n W-phase coils 32W are connected in series. Thus, in the variation, one first coil W1 and one second coil W2 are connected in series. The first coil W1 is disposed in the stator core 31 at two-slot pitch. The second coil W2 is disposed in the stator core 31 at three-slot pitch.

### <Winding Factor>

The winding factor described in the first embodiment is applicable to the stator 3 of the electric motor 1 according to the variation.

### <Method for Fabricating Stator 3 in Variation of First Embodiment>

An example of a method for fabricating the stator 3 in a variation of the first embodiment will be described.

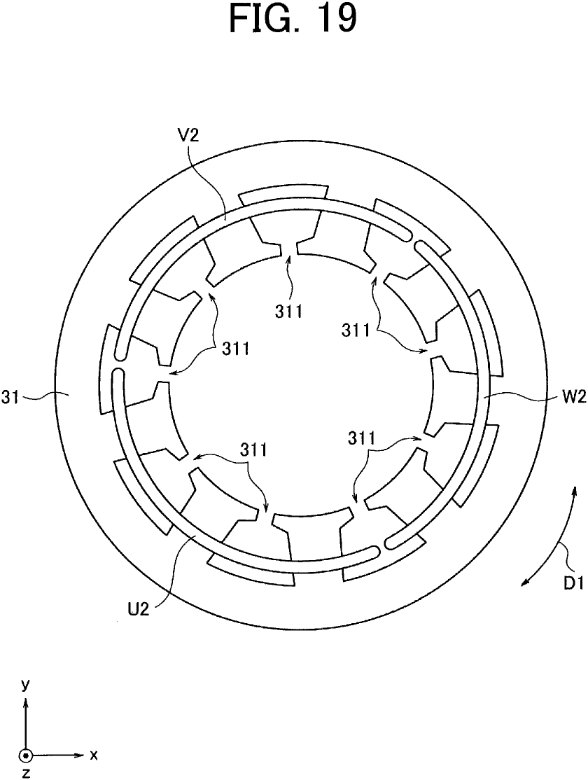

FIG. 18 is a flowchart showing an example of a process of fabricating the stator 3 according to the variation of the first embodiment.

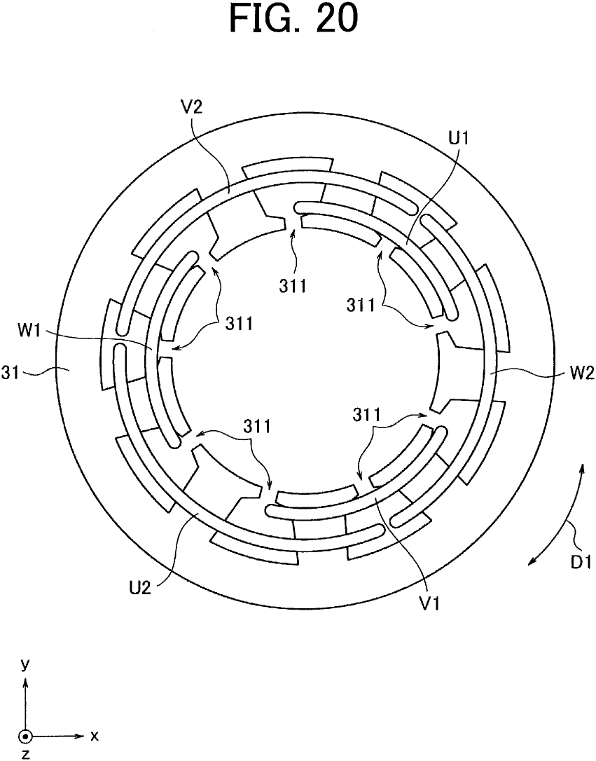

FIG. 19 is a diagram illustrating an insertion step of second coils in step S11a.

In step S11a, as shown in FIG. 18, second coils of the phases are attached to a previously prepared stator core 31 by the inserter 9. Specifically, second coils of each of the phases are disposed at regular intervals (specifically 120 degrees) in the circumferential direction in the coil ends 32a, and the second coils of the phases are disposed in the outer layers of the slots 311 of the stator core 31 by distributed winding. That is, the second coils U2 of the U-phase coils 32U, the second coils V2 of the V-phase coils 32V, and the second coils W2 of the W-phase coils 32W are disposed in the outer layers of the slots 311 by distributed winding. As a result, the second coils of each of the phases are disposed in the outer region in the coil ends 32a, and are arranged in the stator core 31 at three-slot pitch.

In step S12a, the insulator 34 is disposed in the slots 311 where the second coils of each of the phases are disposed to insulate the second coils of each of the phases. Specifically, the insulator 34 is disposed in the slots 311 where the second coils of different phases are disposed.

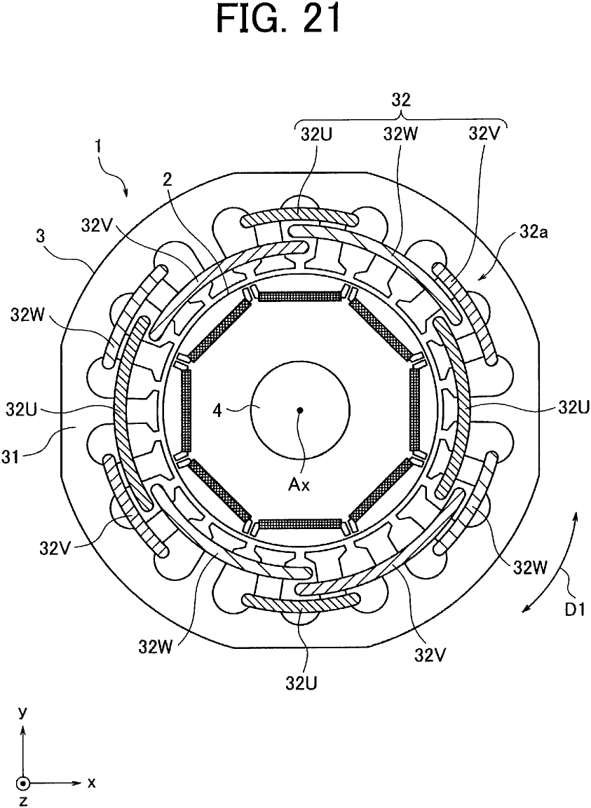

FIG. 20 is a diagram illustrating an insertion step of first coils in step S13a.

In step S13a, as illustrated in FIG. 20, first coils of each of the phases are attached to the stator core 31 by the inserter 9. Specifically, in the coil ends 32a, the first coils of each of the phases are arranged at regular intervals in the circumferential direction, and are disposed in the slots 311 by distributed winding. That is, the first coils U1 of the U-phase coils 32U, the first coils V1 of the V-phase coils 32V, and the first coils W1 of the W-phase coils 32W are disposed in the slots 311 by distributed winding. As a result, the first coils of each of the phases are disposed in the inner region in the coil ends 32a, and disposed inward from the second coils in the radial direction at two-slot pitch.

As described above, in steps S11a through S13a, the first coils are disposed in the stator core 31 at two-slot pitch by distributed winding, and the second coils are disposed in the stator core 31 at three-slot pitch by distributed winding. As a result, the three-phase coils 32 are attached to the stator core 31 by distributed winding such that the three-phase coils 32 have the arrangement described in the variation of this embodiment in the coil ends 32a of the three-phase coils 32 and the slots 311.

In step S14a, the U-phase coils 32U, the V-phase coils 32V, and the W-phase coils 32W are connected to one another. The coils of each phase are connected in series. Specifically, the 2 × n U-phase coils 32U are connected in series, the 2 × n V-phase coils 32V are connected in series, and the 2 × n W-phase coils 32W are connected in series. The U-phase coils 32U, the V-phase coils 32V, and the W-phase coils 32W are connected by Y connection, for example. Thereafter, the shape of the connected three-phase coils 32 are appropriately adjusted. Consequently, the stator 3 illustrated in FIG. 16 is obtained.

The stator 3 according to the variation of the first embodiment has the advantages described in the first embodiment. Thus, the electric motor 1 according to the variation of the first embodiment has the advantages described in the first embodiment.

### Second Embodiment

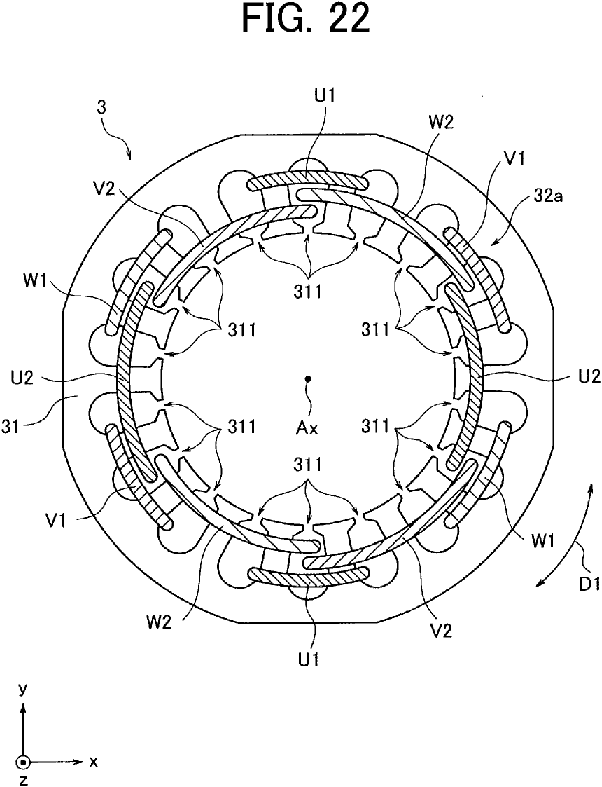

FIG. 21 is a plan view schematically illustrating a structure of an electric motor 1 according to a second embodiment.

In the second embodiment, arrangement of three-phase coils 32 is different from that described in the first embodiment. In the second embodiment, a part of the configuration different from that of the first embodiment will be described. Details not described in the second embodiment are the same as those in the first embodiment.

### <Stator 3>

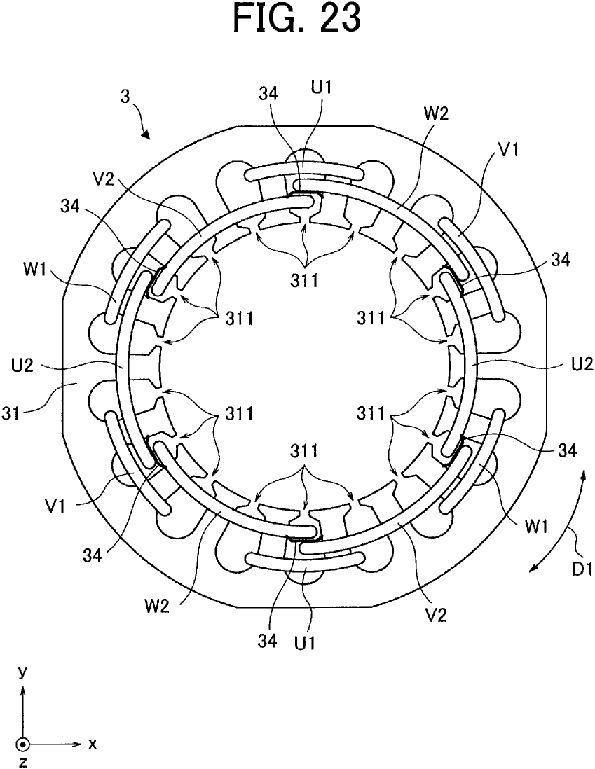

FIG. 22 is a top view schematically illustrating a structure of a stator 3 of the electric motor 1 according to the second embodiment.

As illustrated in FIGS. 21 and 22, the stator 3 includes a stator core 31, and three-phase coils 32 attached to the stator core 31 with distributed winding.

The stator core 31 includes 9 × n (n is an integer equal to or larger than 1) slots 311 in which the three-phase coils 32 are disposed. In this embodiment, n = 2. Thus, in the example illustrated in FIGS. 21 and 22, the stator core 31 includes 18 slots 311.

In the coil ends 32a, the three-phase coils 32 include 2 × n U-phase coils 32U, 2 × n V-phase coils 32V, and 2 × n W-phase coils 32W (see FIG. 21).

The coil group of each phase includes n first coils and n second coils. The first coils are arranged in the stator core 31 at two-slot pitch. The second coils are arranged in the stator core 31 at three-slot pitch.

In this embodiment, n = 2. Thus, in the example illustrated in FIG. 21, in the coil ends 32a, the three-phase coils 32 include four U-phase coils 32U, four V-phase coils 32V, and four W-phase coils 32W. It should be noted that the number of coils of each phase are not limited to four. In this embodiment, the stator 3 has the structure illustrated in FIG. 21 in two coil ends 32a. It should be noted that the stator 3 only needs to have the structure illustrated in FIG. 21 in one of the two coil ends 32a.

When current flows in the three-phase coils 32, the three-phase coils 32 form 4 × n magnetic poles. In this embodiment, n = 2. Thus, in this embodiment, when current flows in the three-phase coils 32, the three-phase coils 32 form eight magnetic poles.

The 2 × n U-phase coils 32U (i.e., the first coils U1 and the second coils U2), the 2 × n V-phase coils 32V (i.e., the first coils V1 and the second coils V2), and the 2 × n W-phase coils 32W (i.e., the first coils W1 and the second coils W2) are connected by, for example, Y connection. Alternatively, the 2 × n U-phase coils 32U, the 2 × n V-phase coils 32V, and the 2 × n W-phase coils 32W may be connected by connection other than Y connection, such as delta connection.

The n first coils of each phase are disposed in the coil ends 32a every 360/n degrees in the circumferential direction at regular intervals. In the case of n = 1, the first coil of each phase is disposed at an arbitrary position in the coil ends 32a.

The n second coils of each phase are disposed in the coil ends 32a every 360/n degrees in the circumferential direction at regular intervals. In the case of n = 1, the second coil of each phase is disposed at an arbitrary position in the coil ends 32a.

In the coil ends 32a, two first coils adjacent to each other in the circumferential direction are shifted from each other by an electrical angle of 240 degrees (i.e., mechanical angle of 60 degrees) in the circumferential direction. In the coil ends 32a, two second coils adjacent to each other in the circumferential direction are shifted from each other by an electrical angle of 240 degrees (i.e., mechanical angle of 60 degrees) in the circumferential direction.

In this embodiment, in the coil ends 32a, the first coils are disposed in the outer region, and the second coils are disposed in the inner region. That is, the first coils are disposed outward from the second coils in the radial direction in the coil ends 32a. The second coils are disposed inward from the first coils in the radial direction in the coil ends 32a.

In this embodiment, the inner region where the second coils are disposed may be divided into a first inner region and a second inner region. The first inner region is a region located inward from the outer region in the xy plane, and the second inner region is a region located inward from the first inner region in the xy plane. That is, the first inner region is a region located between the outer region and the second inner region. Each of the first inner region and the second inner region is a region extending in the circumferential direction. In this case, as illustrated in FIGS. 21 and 22, one second coil of each phase is located in the first inner region, and another second coil of each phase is disposed in the second inner region. Thus, in each phase, one second coil is disposed outward from the other second coil in the radial direction.

In the coil ends 32a, the first coils U1 of the U phase, the first coils W1 of the W phase, and the first coils V1 of the V phase are arranged in this order in the circumferential direction (counterclockwise in FIG. 22). In the coil ends 32a, the second coils U2 of the U phase, the second coils W2 of the W phase, and the second coils V2 of the V phase are arranged in this order in the circumferential direction (counterclockwise in FIG. 3). The second coils are disposed in the slots 311 together with the second coils of another phase.

When seen in the circumferential direction, the coils are wound around the stator core 31 in the same direction.

### <U-phase Coils 32U>

As illustrated in FIG. 22, the 2 × n U-phase coils 32U include n first coils U1 and n second coils U2. In this embodiment, two U-phase coils 32U are constituted by one first coil U1 and one second coil U2. The 2 × n U-phase coils 32U are connected in series. Thus, in this embodiment, two first coils U1 and two second coils U2 are connected in series. The first coil U1 is disposed in the stator core 31 at two-slot pitch. The second coil U2 is disposed in the stator core 31 at three-slot pitch.

As illustrated in FIG. 22, the first coil U1 of the U phase is disposed across one slot in two slots 311 at one side of the stator core 31. In other words, the first coil U1 of the U phase is disposed in two slots 311 with one slot 311 interposed therebetween at one side of the stator core 31.

As illustrated in FIG. 22, the second coil U2 of the U phase is disposed across two slots in two slots 311 at one side of the stator core 31. In other words, the second coil U2 of the U phase is disposed in two slots 311 with two slots 311 interposed therebetween at one side of the stator core 31.

The n first coils U1 of the U phase are disposed in the coil ends 32a every 360/n degrees in the circumferential direction at regular intervals. It should be noted that in the case of n = 1, the first coil U1 is disposed at an arbitrary position in the coil ends 32a. The n second coils U2 of the U phase are disposed in the coil ends 32a every 360/n degrees in the circumferential direction at regular intervals. It should be noted that in the case of n = 1, the second coil U2 is disposed at an arbitrary position in the coil ends 32a.

The first coils U1 are disposed outward from the second coils of another phase in the radial direction in the coil ends 32a. The second coils U2 are disposed inward from the first coils of another phase in the radial direction in the coil ends 32a.

### <V-phase Coils 32V>

As illustrated in FIG. 22, the 2 × n V-phase coils 32V include n first coils V1 and n second coils V2. In this embodiment, the two V-phase coils 32V are constituted by one first coil V1 and one second coil V2. The 2 × n V-phase coils 32V are connected in series. Thus, in this embodiment, two first coils V1 and two second coil V2 are connected in series. The first coils V1 are disposed in the stator core 31 at two-slot pitch. The second coils V2 are disposed in the stator core 31 at three-slot pitch.

As illustrated in FIG. 22, the first coils V1 of the V phase are disposed across one slot in two slots 311 at one side of the stator core 31. In other words, the first coils V1 of the V phase are disposed in two slots 311 with one slot 311 interposed therebetween at one side of the stator core 31.

As illustrated in FIG. 22, the second coils V2 of the V phase is disposed across two slots in two slots 311 at one side of the stator core 31. In other words, the second coils V2 of the V phase are disposed in two slots 311 with two slots 311 interposed therebetween at one side of the stator core 31.

The n first coils V1 of the V phase are disposed in the coil ends 32a every 360/n degrees in the circumferential direction at regular intervals. It should be noted that in the case of n = 1, the first coil V1 is disposed at an arbitrary position in the coil ends 32a. The n second coils V2 of the V phase are disposed in the coil ends 32a every 360/n degrees in the circumferential direction at regular intervals. It should be noted that in the case of n = 1, the second coil V2 is disposed at an arbitrary position in the coil ends 32a.

The first coils V1 are disposed outward from the second coils of another phase in the radial direction in the coil ends 32a. The second coils V2 are disposed inward from the first coils of another phase in the radial direction in the coil ends 32a.

### <W-phase Coils 32W>

As illustrated in FIG. 22, the 2 × n W-phase coils 32W include n first coils W1 and n second coils W2. In this embodiment, two W-phase coils 32W are constituted by one first coil W1 and one second coil W2. The 2 × n W-phase coils 32W are connected in series. Thus, in this embodiment, two first coils W1 and two second coils W2 are connected in series. The first coils W1 are disposed in the stator core 31 at two-slot pitch. The second coils W2 are disposed in the stator core 31 at three-slot pitch.

As illustrated in FIG. 22, the first coils W1 of the W phase are disposed across one slot in two slots 311 at one side of the stator core 31. In other words, the first coils W1 of the W phase are disposed in two slots 311 with one slot 311 interposed therebetween at one side of the stator core 31.

As illustrated in FIG. 22, the second coils W2 of the W phase are disposed across two slots in two slots 311 at one side of the stator core 31. In other words, the second coils W2 of the W phase are disposed in two slots 311 with two slots 311 interposed therebetween at one side of the stator core 31.

The n first coils W1 of the W phase are disposed in the coil ends 32a every 360/n degrees in the circumferential direction at regular intervals. It should be noted that in the case of n = 1, the first coil W1 is disposed at an arbitrary position in the coil ends 32a. The n second coils W2 of the W phase are disposed in the coil ends 32a every 360/n degrees in the circumferential direction at regular intervals. It should be noted that in the case of n = 1, the second coil W2 is disposed at an arbitrary position in the coil ends 32a.

The first coils W1 are disposed outward from the second coils of another phase in the radial direction in the coil ends 32a. The second coils W2 are disposed inward from the first coils of another phase in the radial direction in the coil ends 32a.

### <Insulator>

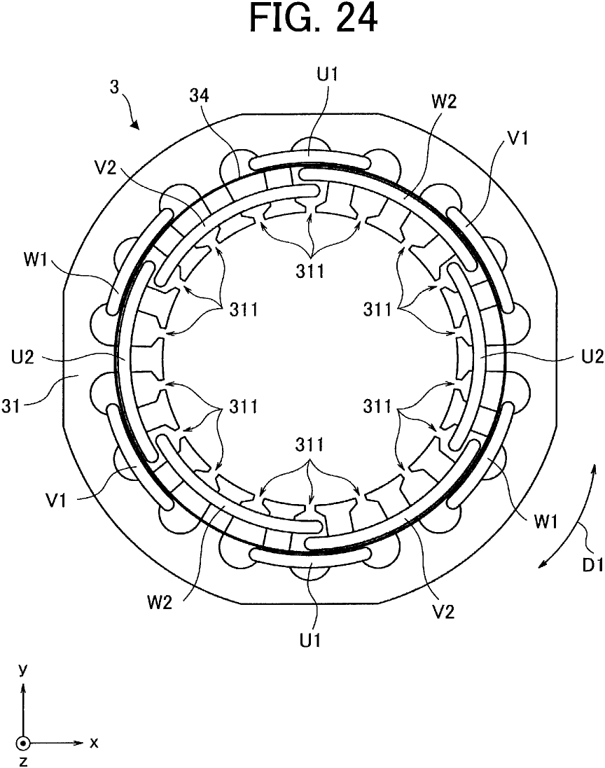

FIG. 23 is a diagram illustrating an example of arrangement of insulators 34 (also referred to as first insulators) in slots 311.

The stator 3 may include the insulators 34 that insulate coils of the phases of the three-phase coils 32. The insulators 34 are, for example, insulating paper. In the example illustrated in FIG. 23, the insulator 34 are disposed in slots 311 where the second coils are disposed in 9 × n slots 311. Specifically, each of the insulators 34 is disposed between two second coils in the slots 311.

In a case where coils of two different phases are disposed in one slot 311, a potential difference occurs between these two coils during rotation of the rotor 2. Thus, in the case where the insulator 34 is disposed between the two coils, dielectric breakdown of coating covering the coils due to the potential difference can be prevented.

FIG. 24 is a diagram illustrating an example of arrangement of an insulator 34 (also referred to as a second insulator) in the coil ends 32a.

The stator 3 may include the insulator 34 that insulates coils of each phase of the three-phase coils 32 in the coil ends 32a. The insulator 34 is, for example, insulating paper. In the example illustrated in FIG. 24, the insulator 34 is disposed between the first coils and the second coils in the coil ends 32a.

### <Winding Factor>

The winding factor described in the first embodiment is applicable to the second embodiment.

### <Method for Fabricating Stator 3 in Second Embodiment>

An example of a method for fabricating the stator 3 in the second embodiment will be described.

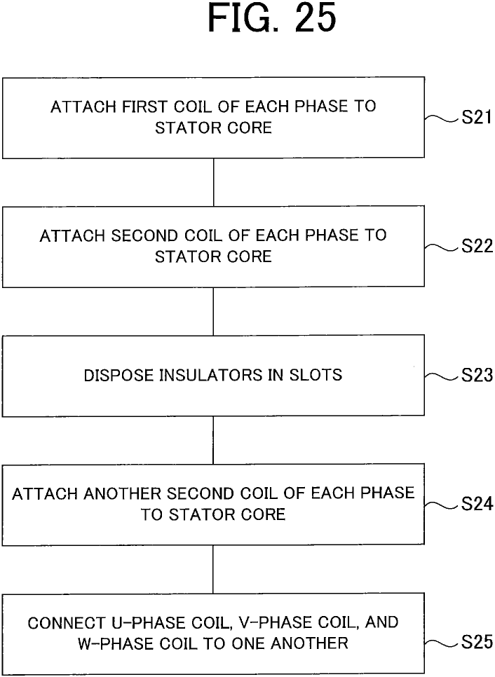

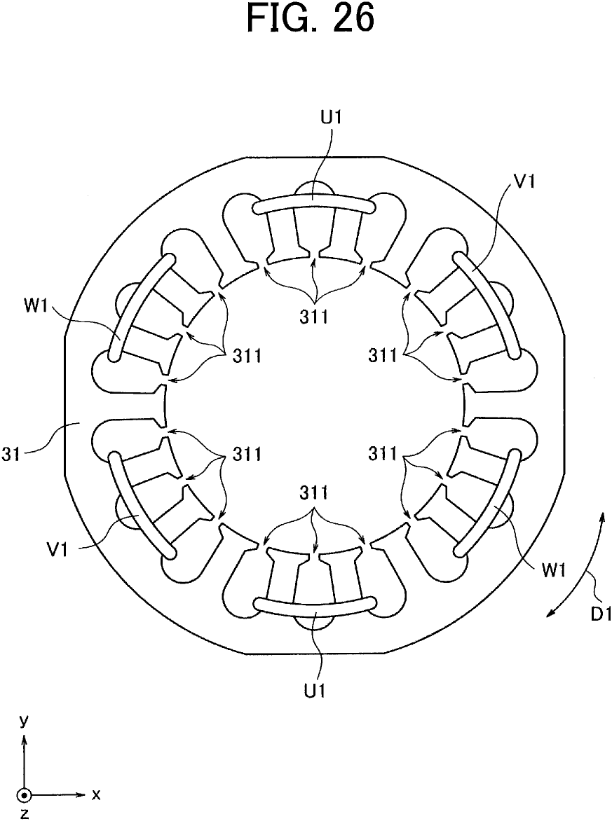

FIG. 25 is a flowchart showing an example of a process of fabricating the stator 3 according to the second embodiment.

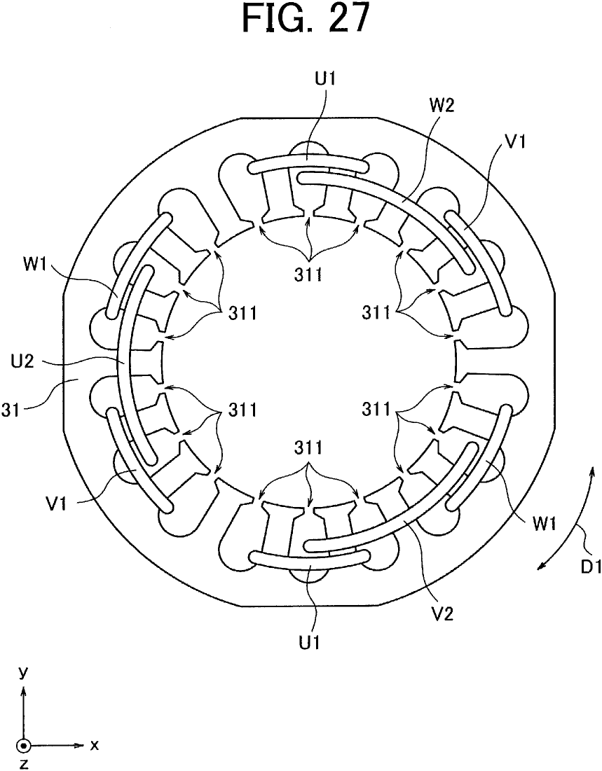

FIG. 26 is a diagram illustrating an insertion step of first coils in step S21.

In step S21, as illustrated in FIG. 26, first coils of each of the phases are attached to the stator core 31 by the inserter 9. Specifically, in the coil ends 32a, the first coils of each of the phases are arranged at regular intervals in the circumferential direction, and are disposed in the slots 311 by distributed winding. That is, the first coils U1 of the U-phase coils 32U, the first coils V1 of the V-phase coils 32V, and the first coils W1 of the W-phase coils 32W are disposed in the slots 311 by distributed winding. As a result, the first coils of each of the phases are disposed in the outer region in the coil ends 32a, and are arranged in the stator core 31 at two-slot pitch.

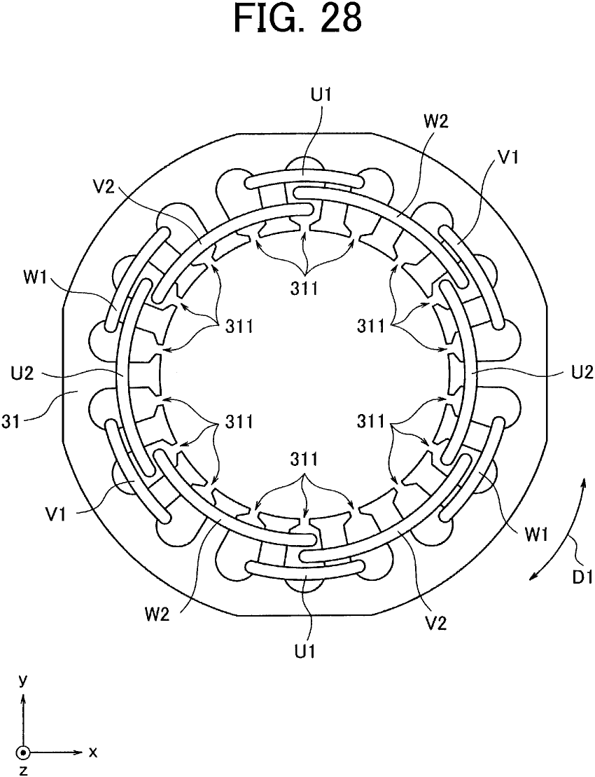

FIG. 27 is a diagram illustrating an insertion step of second coils in step S22.

In step S22, as shown in FIG. 27, second coils of each of the phases are attached to a previously prepared stator core 31 by the inserter 9. Specifically, second coils each of which corresponds to one of the phases are disposed at regular intervals (specifically 120 degrees) in the circumferential direction in the coil ends 32a, and disposed in the outer layers of the slots 311 by distributed winding. That is, one second coil U2 of the U-phase coils 32U, one second coil V2 of the V-phase coils 32V, and one second coil W2 of the W-phase coils 32W are disposed in the outer layers of the slots 311 by distributed winding. As a result, one second coil of each phase is disposed in the inner region (specifically first inner region) in the coil ends 32a. That is, the first coils are disposed outward from the second coils in the radial direction in the coil ends 32a, and the second coils are disposed inward from the first coils in the radial direction at three-slot pitch in the coil ends 32a.

In step S23, the insulator 34 is disposed in the slots 311 where the second coils of the phases are disposed to insulate the second coils of the phases. Specifically, the insulator 34 is disposed in the slots 311 where the second coils of different phases are to be disposed in the next step.

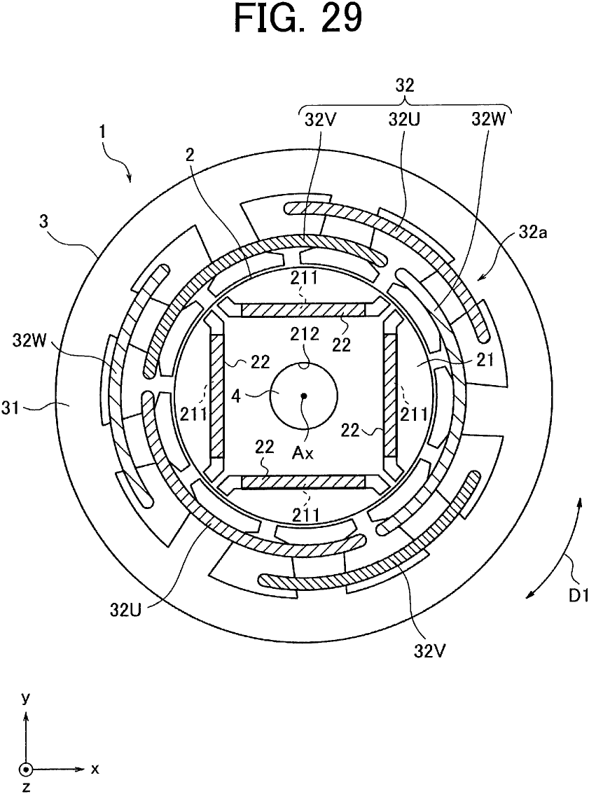

FIG. 28 is a diagram illustrating an insertion step of additional second coils in step S24.

In step S24, as illustrated in FIG. 28, another second coil of each phase is attached to the stator core 31 by the inserter 9. Specifically, other second coils each of which corresponds to one of the phases are disposed at regular intervals in the circumferential direction in the coil ends 32a, and disposed by distributed winding in the inner layers of the slots 311 where the second coils are already disposed. That is, another second coil of each phase is disposed in the inner region (specifically the second inner region) in the coil ends 32a.

As a result, the second coils of the phases are disposed in the inner region in the coil ends 32a, and disposed inward from the first coils in the radial direction at three-slot pitch. Regarding the second coils of each of the phases, in the coil ends 32a, the second coils U2 of the U phase, the second coils W2 of the W phase, and the second coils V2 of the V phase are arranged in this order in the circumferential direction (counterclockwise in FIG. 28). The second coils are disposed in the slots 311 together with second coils of other phases. Consequently, the second coils are disposed inward from the first coils in the radial direction in the coil ends 32a.

As described above, in steps S21 through S24, the first coils are disposed in the stator core 31 at two-slot pitch by distributed winding, and the second coils are disposed in the stator core 31 at three-slot pitch by distributed winding. As a result, the three-phase coils 32 are attached to the stator core 31 by distributed winding such that the three-phase coils 32 have the arrangement described in this embodiment in the coil ends 32a of the three-phase coils 32 and the slots 311.

In step S25, the U-phase coils 32U, the V-phase coils 32V, and the W-phase coils 32W are connected to one another. The coils of each phase are connected in series. Specifically, the 2 × n U-phase coils 32U are connected in series, the 2 × n V-phase coils 32V are connected in series, and the 2 × n W-phase coils 32W are connected in series. The U-phase coils 32U, the V-phase coils 32V, and the W-phase coils 32W are connected by Y connection, for example. Thereafter, the shape of the connected three-phase coils 32 are appropriately adjusted. Consequently, the stator 3 illustrated in FIG. 22 is obtained.

In this embodiment, since the stator 3 has the arrangement described above, the three-phase coils 32 can be easily attached to the stator core 31 by using an inserter (e.g., inserter 9 illustrated in FIG. 9). Thus, productivity of the stator 3 can be increased. In addition, in this embodiment, since the stator 3 has the arrangement described above, an insulator 34 can be easily disposed in slots 311, and productivity of the stator 3 can be further increased.

With the method for fabricating the stator 3 according to the first embodiment, the stator 3 having the advantages described in this embodiment can be fabricated. In addition, with the method for fabricating the stator 3, the three-phase coils 32 can be attached to the stator core 31 by using the inserter 9.

In the coil ends 32a, each second coil has a diameter smaller than that of each first coil. In this case, the shape of the second coils can be easily adjusted. Thus, the first coils whose diameter is larger than that of the second coils are first disposed in the outer region, and thus, the second coils can be easily disposed in the stator core 31 after the first coils are disposed in the outer region.

### Variation of Second Embodiment

### <Electric Motor 1>

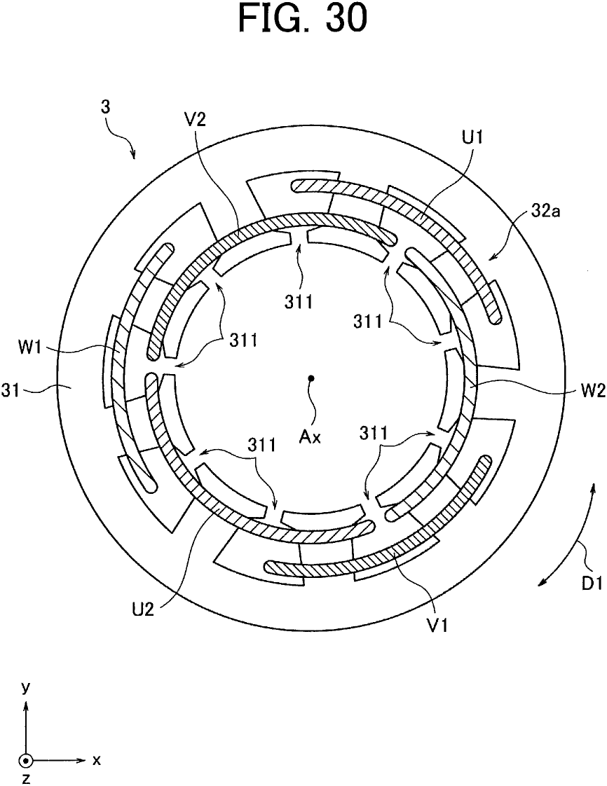

FIG. 29 is a top view schematically illustrating a structure of an electric motor 1 according to a variation of the second embodiment.

In this variation, the value of “n” is different from the value of “n” described in the second embodiment. In the variation of the second embodiment, n = 1. In the variation of the second embodiment, a part of the configuration different from that of the second embodiment will be described. Details not described in the variation of the second embodiment are the same as those in the second embodiment.

A rotor 2 includes a rotor core 21 and at least one permanent magnet 22. The rotor 2 has 4 × n (n is an integer equal to or larger than 1) magnetic poles. In the variation, the rotor 2 has four magnetic poles.

### <Stator 3>

FIG. 30 is a top view schematically illustrating a structure of a stator 3 of the electric motor 1 according to the variation of the second embodiment.

The stator core 31 has 9 × n slots 311 in which the three-phase coils 32 are disposed. In the variation, n = 1. Thus, in the variation, the stator core 31 has nine slots 311.

In the example illustrated in FIG. 30, in the coil ends 32a, the three-phase coils 32 include two U-phase coils 32U, two V-phase coils 32V, and two W-phase coils 32W.

When current flows in the three-phase coils 32, the three-phase coils 32 form 4 × n magnetic poles. In the variation, n = 1. Thus, in the variation, when current flows through the three-phase coils 32, the three-phase coils 32 form four magnetic poles.

In the variation of the second embodiment, the coil group of each phase includes one first coil and one second coil. The first coils are arranged in the stator core 31 at two-slot pitch. The second coils are arranged in the stator core 31 at three-slot pitch.

As illustrated in FIG. 30, the 2 × n U-phase coils 32U (i.e., one first coil U1 and one second coil U2), the 2 × n V-phase coils 32V (i.e., one first coil V1 and one second coil V2), and the 2 × n W-phase coils 32W (i.e., one first coil W1 and one second coil W2) are connected by, for example, Y connection. Alternatively, the 2 × n U-phase coils 32U, the 2 × n V-phase coils 32V, and the 2 × n W-phase coils 32W may be connected by connection other than Y connection, such as delta connection.

### <U-phase Coils 32U>

The 2 × n U-phase coils 32U include n first coils U1 and n second coils U2. In the variation, four U-phase coils 32U are constituted by two first coils U1 and two second coils U2. The 2 × n U-phase coils 32U are connected in series. Thus, in the variation, one first coil U1 and one second coil U2 are connected in series. The first coil U1 is disposed in the stator core 31 at two-slot pitch. The second coil U2 is disposed in the stator core 31 at three-slot pitch.

### <V-phase Coils 32V>

The 2 × n V-phase coils 32V include n first coils V1 and n second coils V2. In the variation, four V-phase coils 32V are constituted by two first coils V1 and two second coils V2. The 2 × n V-phase coils 32V are connected in series. Thus, in the variation, one first coil V1 and one second coil V2 are connected in series. The first coils V1 are disposed in the stator core 31 at two-slot pitch. The second coils V2 are disposed in the stator core 31 at three-slot pitch.

### <W-phase Coils 32W>

The 2 × n W-phase coils 32W include n first coils W1 and n second coils W2. In the variation, four W-phase coils 32W are constituted by two first coils W1 and two second coils W2. The 2 × n W-phase coils 32W are connected in series. Thus, in the variation, one first coil W1 and one second coil W2 are connected in series. The first coils W1 are disposed in the stator core 31 at two-slot pitch. The second coils W2 are disposed in the stator core 31 at three-slot pitch.

### <Winding Factor>

The winding factor described in the first embodiment is applicable to the stator 3 of the electric motor 1 according to the variation of the second embodiment.

### <Method for Fabricating Stator 3 in Variation of Second Embodiment>

An example of a method for fabricating the stator 3 in the variation of the second embodiment will be described.

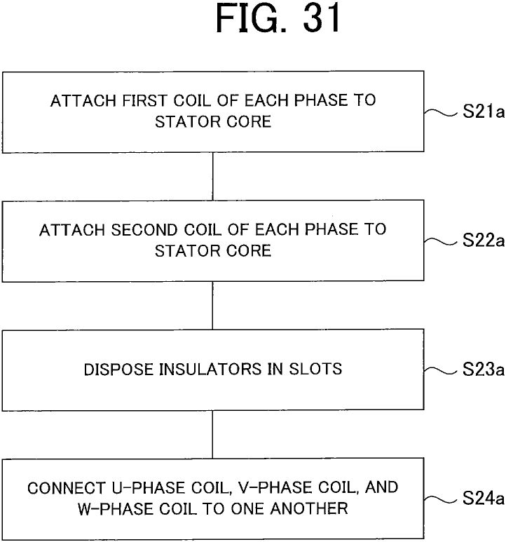

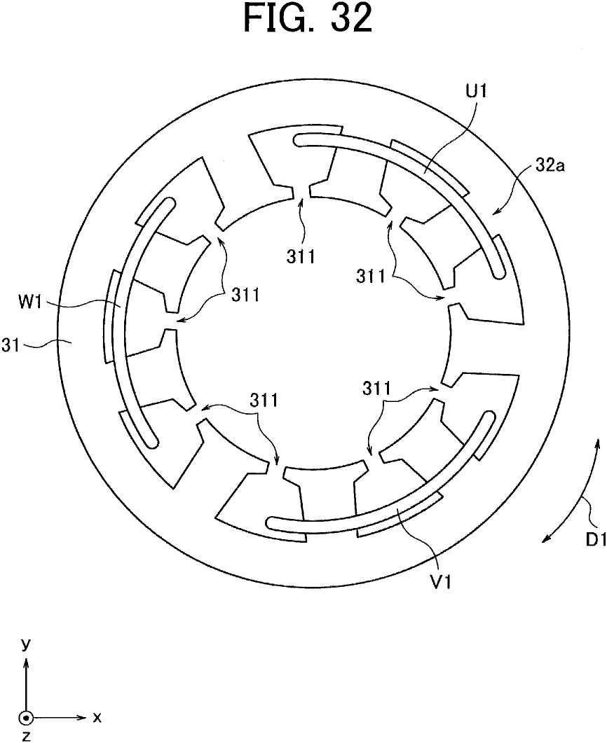

FIG. 31 is a flowchart showing an example of a process of fabricating the stator 3 according to the variation of the second embodiment.

FIG. 32 is a diagram illustrating an insertion step of first coils in step S21a.

In step S21a, as shown in FIG. 32, first coils of the phases are attached to a previously prepared stator core 31 by an inserter 9. Specifically, in the coil ends 32a, first coils each of which corresponds to one of the phases are disposed at regular intervals in the circumferential direction, and disposed in the slots 311 by distributed winding. Specifically, one first coil U1 of the U-phase coils 32U, one first coil V1 of the V-phase coils 32V, and one first coil W1 of the W-phase coils 32W are disposed in the slots 311 by distributed winding. As a result, the first coils of the phases are disposed in the outer region in the coil ends 32a, and are arranged in the stator core 31 at two-slot pitch.

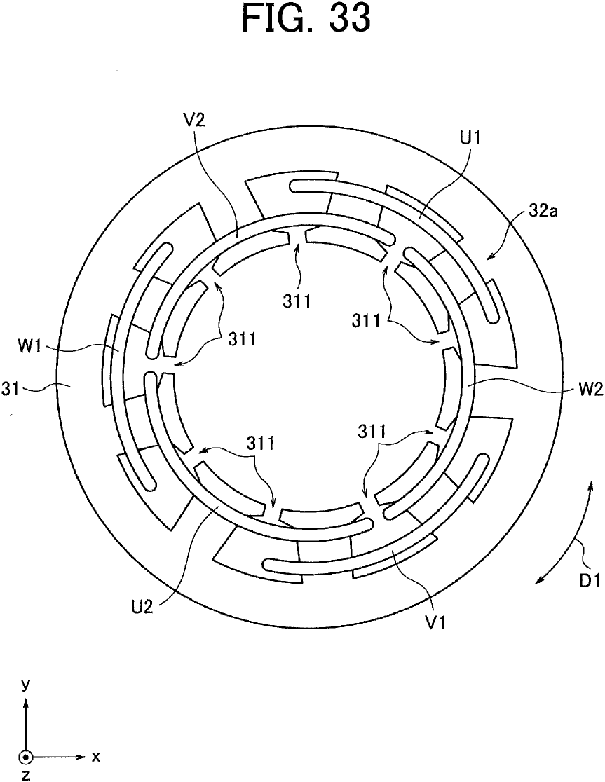

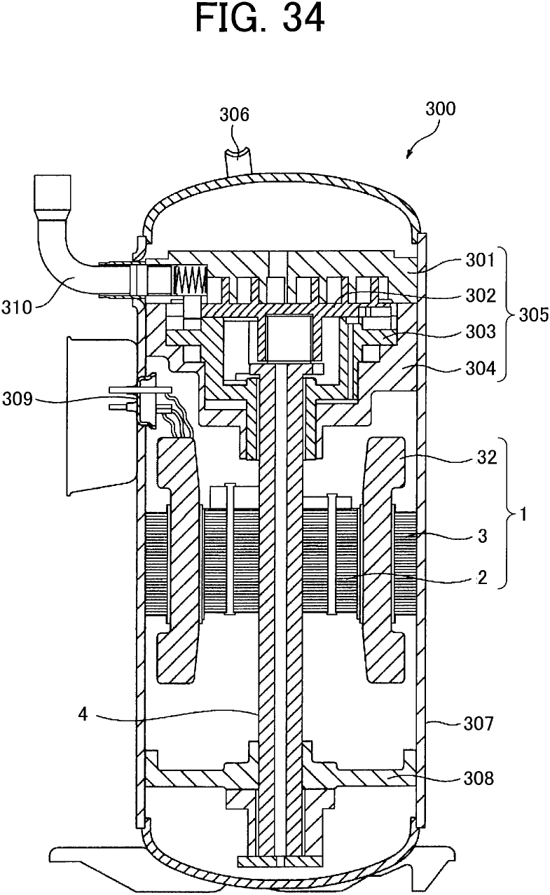

FIG. 33 is a diagram illustrating an insertion step of second coils in step S22a.

In step S22a, as shown in FIG. 33, second coils of the phases are attached to a previously prepared stator core 31 by the inserter 9. Specifically, second coils of the phases are disposed at regular intervals (specifically 120 degrees) in the circumferential direction in the coil ends 32a, and disposed in the outer layers of the slots 311 of the stator core 31 by distributed winding. That is, the second coils U2 of the U-phase coils 32U, the second coils V2 of the V-phase coils 32V, and the second coils W2 of the W-phase coils 32W are disposed in the outer layers of the slots 311 by distributed winding. As a result, the second coils of the phases are disposed in the inner region in the coil ends 32a, and disposed inward from the first coils in the radial direction at three-slot pitch.

In step S23a, the insulator 34 is disposed in the slots 311 where the second coils of the phases are disposed to insulate the second coils of the phases. Specifically, the insulator 34 is disposed in the slots 311 where the second coils of different phases are disposed.

As described above, in steps S21a through S23a, the first coils are disposed in the stator core 31 at two-slot pitch by distributed winding, and the second coils are disposed in the stator core 31 at three-slot pitch by distributed winding. As a result, the three-phase coils 32 are attached to the stator core 31 by distributed winding such that the three-phase coils 32 have the arrangement described in the variation of this embodiment in the coil ends 32a of the three-phase coils 32 and the slots 311.

In step S24a, the U-phase coils 32U, the V-phase coils 32V, and the W-phase coils 32W are connected to one another. The coils of each phase are connected in series. Specifically, the 2 × n U-phase coils 32U are connected in series, the 2 × n V-phase coils 32V are connected in series, and the 2 × n W-phase coils 32W are connected in series. The U-phase coils 32U, the V-phase coils 32V, and the W-phase coils 32W are connected by Y connection, for example. Thereafter, the shape of the connected three-phase coils 32 are appropriately adjusted. Consequently, the stator 3 illustrated in FIG. 30 is obtained.

The stator 3 according to the variation of the second embodiment has the advantages described in the second embodiment. Thus, the electric motor 1 according to the variation of the second embodiment has the advantages described in the second embodiment.

### Third Embodiment

A compressor 300 according to a third embodiment will be described.

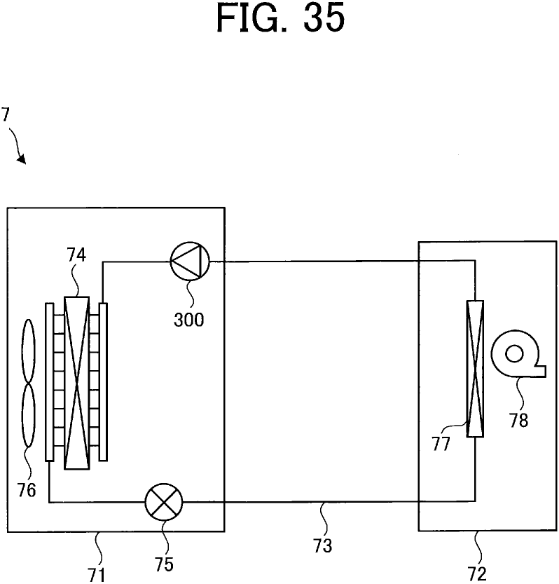

FIG. 34 is a cross-sectional view schematically illustrating a structure of the compressor 300.

The compressor 300 includes an electric motor 1 as an electric element, a closed container 307 as a housing, and a compression mechanism 305 as a compression element (also referred to as a compression device). In this embodiment, the compressor 300 is a scroll compressor. The compressor 300 is not limited to the scroll compressor. The compressor 300 may be a compressor except for the scroll compressor, such as a rotary compressor.

The electric motor 1 in the compressor 300 is the electric motor 1 described in the first or second embodiment (including the variations thereof). The electric motor 1 drives the compression mechanism 305.

The compressor 300 includes a subframe 308 supporting a lower end (i.e., an end opposite to the compression mechanism 305) of a shaft 4.

The compression mechanism 305 is disposed inside the closed container 307. The compressor mechanism 305 includes a fixed scroll 301 having a spiral portion, a swing scroll 302 having a spiral portion forming a compression chamber between the spiral portion of the swing scroll 302 and the spiral portion of the fixed scroll 301, a compliance frame 303 holding an upper end of the shaft 4, and a guide frame 304 fixed to the closed container 307 and holding the compliance frame 303.

A suction pipe 310 penetrating the closed container 307 is press fitted in the fixed scroll 301. The closed container 307 is provided with a discharge pipe 306 that discharges a high-pressure refrigerant gas discharged from the fixed scroll 301, to the outside. The discharge pipe 306 communicates with an opening provided between the compressor mechanism 305 of the closed container 307 and the electric motor 1.

The electric motor 1 is fixed to the closed container 307 by fitting the stator 3 in the closed container 307. The configuration of the electric motor 1 has been described above. To the closed container 307, a glass terminal 309 for supplying electric power to the electric motor 1 is fixed by welding.

When the electric motor 1 rotates, this rotation is transferred to the swing scroll 302, and the swing scroll 302 swings. When the swing scroll 302 swings, the volume of the compression chamber formed by the spiral portion of the swing scroll 302 and the spiral portion of the fixed scroll 301 changes. Then, a refrigerant gas is sucked from the suction pipe 310, compressed, and then discharged from the discharge pipe 306.

The compressor 300 includes the electric motor 1 described in the first or second embodiment, and thus, has the advantages described in the first or second embodiment.

In addition, since the compressor 300 includes the electric motor 1 described in the first or second embodiment, performance of the compressor 300 can be improved.

### Fourth Embodiment

A refrigeration air conditioning apparatus 7 serving as an air conditioner and including the compressor 300 according to the third embodiment will be described.

FIG. 35 is a diagram schematically illustrating a configuration of the refrigerating air conditioning apparatus 7 according to a fourth embodiment.

The refrigeration air conditioning apparatus 7 is capable of performing cooling and heating operations, for example. The refrigerant circuit diagram illustrated in FIG. 35 is an example of a refrigerant circuit diagram of an air conditioner capable of performing a cooling operation.

The refrigeration air conditioning apparatus 7 according to the fourth embodiment includes an outdoor unit 71, an indoor unit 72, and a refrigerant pipe 73 connecting the outdoor unit 71 and the indoor unit 72.

The outdoor unit 71 includes a compressor 300, a condenser 74 as a heat exchanger, a throttling device 75, and an outdoor air blower 76 (first air blower). The condenser 74 condenses a refrigerant compressed by the compressor 300. The throttling device 75 decompresses the refrigerant condensed by the condenser 74 to thereby adjust a flow rate of refrigerant. The throttling device 75 will be also referred to as a decompression device.

The indoor unit 72 includes an evaporator 77 as a heat exchanger, and an indoor air blower 78 (second air blower). The evaporator 77 evaporates the refrigerant decompressed by the throttling device 75 to thereby cool indoor air.

A basic operation of a cooling operation in the refrigeration air conditioning apparatus 7 will now be described. In the cooling operation, a refrigerant is compressed by the compressor 300 and the compressed refrigerant flows into the condenser 74. The condenser 74 condenses the refrigerant, and the condensed refrigerant flows into the throttling device 75. The throttling device 75 decompresses the refrigerant, and the decompressed refrigerant flows into the evaporator 77. In the evaporator 77, the refrigerant evaporates, and the refrigerant (specifically a refrigerant gas) flows into the compressor 300 of the outdoor unit 71 again. When the air is sent to the condenser 74 by the outdoor air blower 76, heat moves between the refrigerant and the air. Similarly, when the air is sent to the evaporator 77 by the indoor air blower 78, heat moves between the refrigerant and the air.

The configuration and operation of the refrigeration air conditioning apparatus 7 described above are examples, and the present disclosure is not limited to the examples described above.

The refrigeration air conditioning apparatus 7 according to the fourth embodiment has the advantages described in the first or second embodiment.

In addition, since the refrigeration air conditioning apparatus 7 according to the fourth embodiment includes the compressor 300 according to the third embodiment, performance of the refrigeration air conditioning apparatus 7 can be improved.

Features of the embodiments described above and features of variations thereof can be combined.

What is claimed is:

1. A stator comprising:
a stator core including 9 × n (n is an integer equal to or larger than 1) slots;
three-phase coils attached to the stator core by distributed winding and to form 4 × n magnetic poles; and
a first insulator insulating the three-phase coils, wherein
the three-phase coils include 2 × n U-phase coils, 2 × n V-phase coils, and 2 × n W-phase coils in a coil end of the three-phase coils,
the 2 × n U-phase coils are connected in series,
the 2 × n V-phase coils are connected in series,
the 2 × n W-phase coils are connected in series,
each of the 2 × n U-phase coils, the 2 × n V-phase coils, and the 2 × n W-phase coils includes n first coils disposed in the stator core at two-slot pitch and n second coils disposed in the stator core at three-slot pitch,
the n first coils are disposed in the coil end every 360/n degrees in a circumferential direction at regular intervals,
the n second coils are disposed in the coil end every 360/n degrees in the circumferential direction at regular intervals,
the n second coils are disposed outward from the n first coils in a radial direction in the coil end, and
the first insulator is disposed in a slot in which the second coil is disposed, of the 9 × n slots.

2. A stator comprising:
a stator core including 9 × n (n is an integer equal to or larger than 1) slots;
three-phase coils attached to the stator core by distributed winding and to form 4 × n magnetic poles; and
a first insulator insulating the three-phase coils, wherein
the three-phase coils include 2 × n U-phase coils, 2 × n V-phase coils, and 2 × n W-phase coils in a coil end of the three-phase coils,
the 2 × n U-phase coils are connected in series,
the 2 × n V-phase coils are connected in series,
the 2 × n W-phase coils are connected in series,
each of the 2 × n U-phase coils, the 2 × n V-phase coils, and the 2 × n W-phase coils includes n first coils disposed in the stator core at two-slot pitch and n second coils disposed in the stator core at three-slot pitch,
the n first coils are disposed in the coil end every 360/n degrees in a circumferential direction at regular intervals,
the n second coils are disposed in the coil end every 360/n degrees in the circumferential direction at regular intervals,
the n first coils are disposed outward from the n second coils in a radial direction in the coil end, and
the first insulator is disposed in a slot in which the second coil is disposed, of the 9 × n slots.

3. The stator according to claim 1, wherein the first insulator is disposed between two of the second coils.

4. The stator according to claim 1, further comprising a second insulator insulating the three-phase coils, wherein
the second insulator is disposed between the first coils and the second coils in the coil end.

5. The stator according to claim 1, wherein the 2 × n U-phase coils, the 2 × n V-phase coils, and the 2 × n W-phase coils are connected to one another by Y connection.

6. An electric motor comprising:
the stator according to claim 1; and
a rotor disposed inside the stator.

7. A compressor comprising:
a closed container;
a compression device disposed in the closed container; and
the electric motor according to claim 6 to drive the compression device.

8. An air conditioner comprising:
the compressor according to claim 7; and
a heat exchanger.

9. A method for fabricating a stator, the stator including a stator core including slots and three-phase coils including 2 × n (n is an integer equal to or larger than 1) U-phase coils, 2 × n V-phase coils, and 2 × n W-phase coils in a coil end,
each of the 2 × n U-phase coils, the 2 × n V-phase coils, and the 2 × n W-phase coils including n first coils and n second coils, the method comprising:
disposing the n second coils in the stator core at three-slot pitch;
disposing an insulator in the slots where the second coils are disposed to insulate the n second coils; and
disposing the n first coils inward from the n second coils in a radial direction at two-slot pitch.

10. A method for fabricating a stator, the stator including a stator core including slots and three-phase coils including 2 × n (n is an integer equal to or larger than 1) U-phase coils, 2 × n V-phase coils, and 2 × n W-phase coils in a coil end,
each of the 2 × n U-phase coils, the 2 × n V-phase coils, and the 2 × n W-phase coils including n first coils and n second coils, the method comprising:
disposing the n first coils in the stator core at two-slot pitch;
disposing the n second coils inward from the n first coils in a radial direction at three-slot pitch; and
disposing an insulator in the slots where the second coils are disposed to insulate the n second coils.
